(19) United States
(12) Patent Application Publication
(10) Pub. No.: US 2008/0160956 A1
(43) Pub. Date: Jul. 3, 2008

(54) METHOD AND SYSTEM FOR DELIVERING AND/OR DISPLAYING TARGETED CONTENT TO A MOBILE HANDHELD DEVICE

(76) Inventors: Jonathan B. Jackson, Arlington, VA (US); Sean Kidder, McLean, VA (US); Anurag Mehta, Sterling, VA (US); Michael Gross, Leesburg, VA (US); Christopher Passante, Great Falls, VA (US); Patricia J. Camp, Bethesda, MD (US); Wayne Lutz, Fort Washington, MD (US); John Lemp, Islip Terrace, NY (US); Heather McKenzie Carlisle, Columbus, OH (US); Eric Newman, Leesburg, VA (US)

Correspondence Address: DLA PIPER US LLP, P. O. BOX 9271, RESTON, VA, 20195, US

(21) Appl. No.: 11/962,001

(22) Filed: Dec. 20, 2007

Related U.S. Application Data
(60) Provisional application No. 60/871,634, filed on Dec. 22, 2006.

(51) Int. Cl. H04M 11/00; H04M 3/42

(52) U.S. Cl. 455/406; 455/414.2

(57) ABSTRACT

A method and system for delivering and displaying content on a mobile handheld device with voice telephony capability. Content is received from or on behalf of a content provider. For each individual one of a plurality of mobile handheld devices, content appropriate for each device is determined. The content determined to be appropriate for each mobile handheld device is delivered individually to that mobile handheld device. It is then determined whether the mobile handheld device is in an internal and/or external predetermined status, wherein the internal predetermined status is a function of the mobile handheld device unrelated to the content. If the mobile handheld device is in the internal and/or external predetermined status, the content is displayed as a foreground to a top-level user interface of the mobile handheld device.

This application claims priority to provisional application 60/871,634, entitled “Method and System for Delivering Advertising to a Reception Device”, filed on Dec. 22, 2006, which is herein incorporated by reference.

### BRIEF DESCRIPTION OF THE DRAWINGS

FIG. 1 illustrates a system for managing, delivering, displaying, and reporting on content sent to a mobile handheld device, according to one embodiment of the invention.

FIG. 2 illustrates a method for delivering and displaying content on a mobile handheld device, according to one embodiment of the invention.

FIGS. 3A-3C illustrates methods of creating content, according to several embodiments of the invention.

FIG. 4 illustrates a method of approving content, according to one embodiment of the invention.

FIG. 5 illustrates a method of delivering content to the mobile handheld devices and recording usage of the content, according to one embodiment of the invention.

FIG. 6 illustrates a method of presenting content on the mobile handheld device, according to one embodiment of the invention.

FIGS. 7A-7C illustrate methods of optimizing network use, according to one embodiment of the invention.

FIGS. 8A-8B illustrate methods of targeting content, according to one embodiment of the invention.

FIG. 9A illustrates a method of forwarding content, according to one embodiment of the invention.

FIG. 9B illustrates a method of rating content, according to one embodiment of the invention.

FIG. 9C illustrates a method of reporting content, according to one embodiment of the invention.

FIG. 9D illustrates a method of searching for information on a mobile handheld device, according to one embodiment of the invention.

FIGS. 10-15 are examples of content, according to several embodiments of the invention.

FIGS. 16-49 are screen shots illustrating features of a system and method of delivering and displaying content to a mobile handheld device, according to several embodiments of the invention.

### DESCRIPTION OF EMBODIMENTS OF THE INVENTION

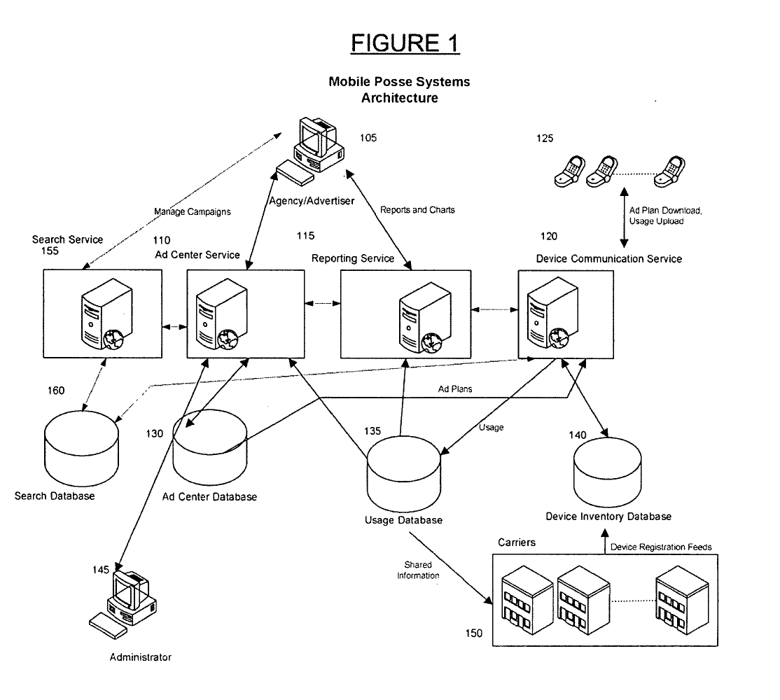

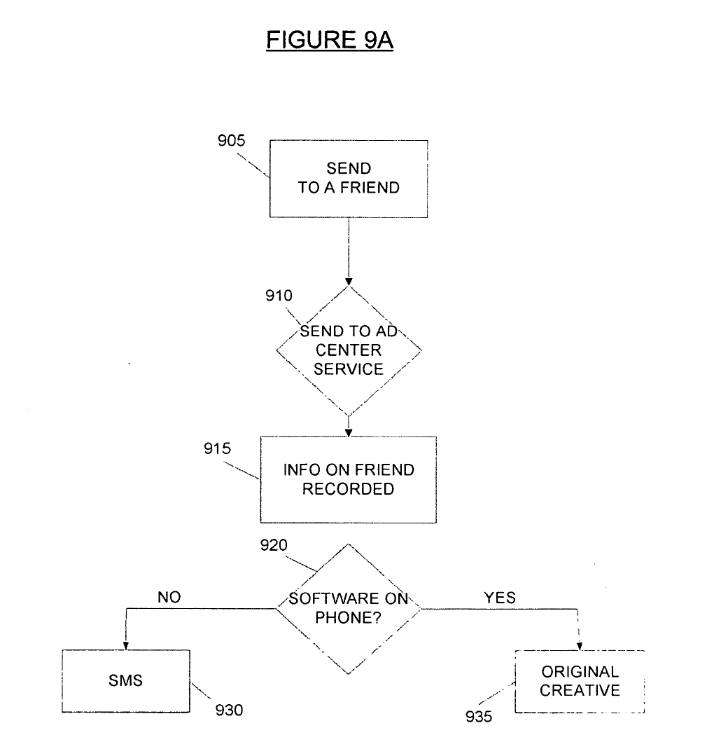

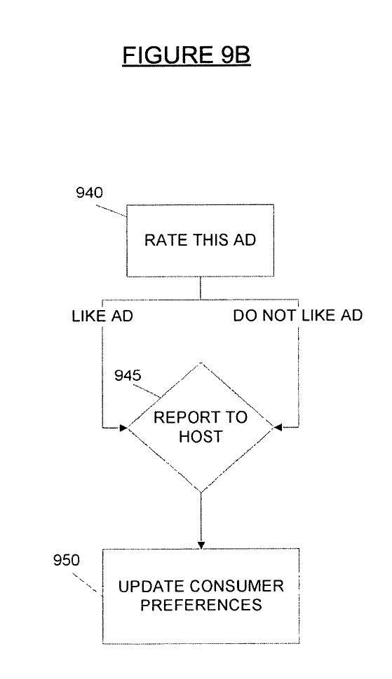

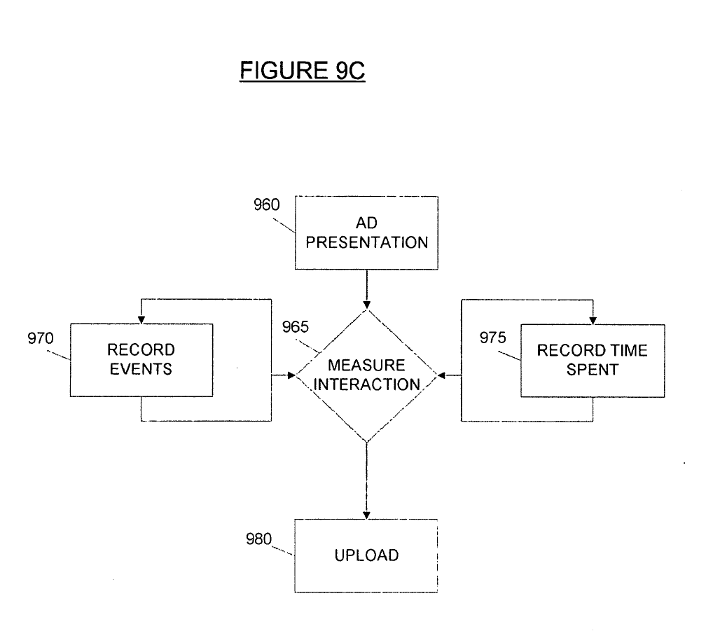

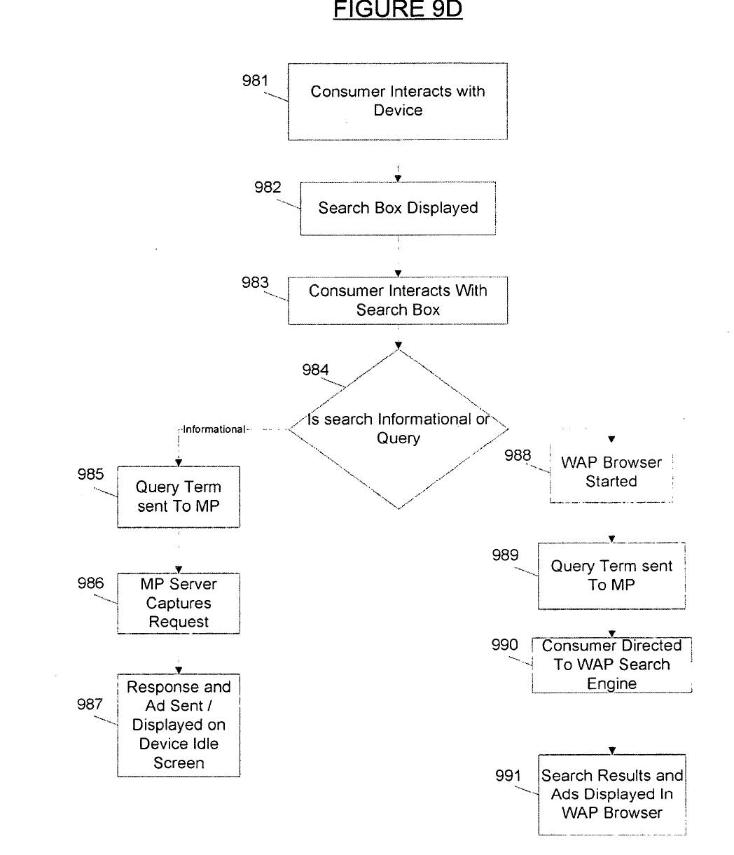

FIG. 1 illustrates a system for delivering and displaying content on a mobile handheld device, according to one embodiment of the invention. In FIG. 1, an example embodiment is given where a mobile handheld device is used to receive content (e.g., advertising). Any type of mobile handheld device can be used, including, but not limited to: a cellular phone, a personal digital assistant (PDA), a computer, a GPS mobile handheld device, any connected computing mobile handheld device, any networked mobile handheld device, or any combination thereof. The embodiments described in this application primarily discuss advertising, but those of ordinary skill in the art will also see that any type of content can be sent, including, but not limited to: advertising, movies, songs, ring tones, wallpaper, video content, audio content, video/audio content, graphical content, textual content, digital content, software applications (e.g., an email reader, a map and/or direction application), rich media, graphic media, animation media, public service announcements, trivia, weather, a call to action, a poll, a survey, data, services or mobile handheld device specified content or any combination thereof. In one embodiment, the content can be rich media and/or graphic media (e.g., FLASH animation). Referring to FIG. 1, in one embodiment, a content provider, utilizing, for example, an agency/advertiser computer 105 manages content, such as advertising campaigns, utilizing a content center service, such as an ad center service 110. Content providers can include, but are not limited to, advertisers, non-profit entities, for-profit entities, government entities, or any combination thereof. An advertiser can be an entity who wants to communicate any message, for example, about their product and/or service, to a set of consumers. An agency can manage the advertising campaigns for one or more advertisers. An advertiser may choose to manage their campaign with or without the help of an agency. Thus, for example, an agency/advertiser could determine four advertisements that it wants to use in an advertising campaign. The agency/advertiser computer 105 would communicate with the ad center service 110 to create this campaign. The ad center service 110 communicates with an ad center database 130 to obtain and save the advertising. In one embodiment, the ad center service 110 is accessed by an administrator, who may use, for example, an administrator computer 145, which manages the advertising campaign to make sure that the right advertising goes to the right mobile handheld devices 125 at the appropriate times. A mobile handheld device inventory database 140 communicates with carriers 150 and a mobile handheld device communication service 120 to ensure that the mobile handheld devices 125 are correctly inventoried, so that the correct users are identified with the right mobile handheld devices. In one embodiment, the mobile handheld device communication service 120, the mobile handheld device inventory database 140, and/or the carriers 150 are also utilized to track the location of the mobile handheld devices 125. A reporting service 115 communicates with the agency/advertiser computer 105 and a usage database 135 to keep accurate records of which advertising is sent to which mobile handheld devices 125. Information from the usage database 135 can also be forwarded to carriers 150. A search service 155 and search database 160 are utilized to search for information after a search has been initiated on a mobile handheld device. This process is defined in more detail in FIG. 9D and its explanatory text below.

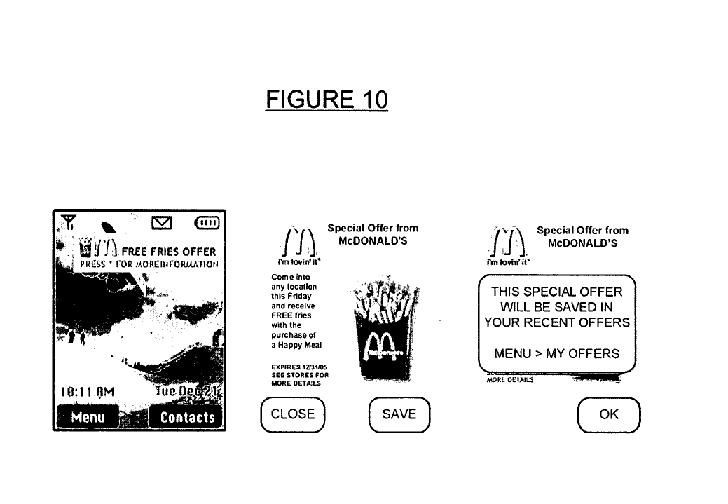

In one embodiment, content such as advertising is displayed on a mobile handheld device. Software on the mobile handheld device allows display of content (e.g., advertisements) to a top level user interface (UI). A top level UI is a UI that is at a top of a hierarchical arrangement of screens (e.g., an idle screen, a home screen, a top screen, an original equipment manufacturer (OEM) screen, a screen that appears once a user has logged in). In one embodiment, the content is delivered to a foreground UI, which is a UI that is active and can receive user input. In one embodiment, the content is displayed in a foreground UI, which is a UI that is active and can receive user input. In one embodiment, the content is displayed in a floating foreground UI, as illustrated, for example, in the first screen of FIG. 10.

It should be noted, that, in other embodiments, the advertising or content could trigger the mobile handheld device to turn on (e.g., when certain conditions are met). Content in the foreground of a top level user interface is to be distinguished from content in the background or wallpaper of the interface. An example of advertising appearing in the foreground of a top level user interface that is an idle screen is illustrated in FIG. 10 In one embodiment, a portion of foreground can be maintained and continuously utilized on the top level user interface to display the content (e.g., advertising, a news ticker, stock quotes, a logo, video feed). The advertising can also be displayed before the user logs in. The advertising can be displayed and/or the user can interact with the advertising without logging in.

Many tools assist in marketing of products and/or services to consumers: ad insertion, targeting, rotation, optimization, serving (e.g., downloading to mobile handheld devices), and performance measurements. The advertising sent to the mobile handheld devices can be targeted by geography, demographics, psychographics (personality characteristics and attitudes that affect a person's lifestyle and purchasing behavior), mobile handheld device characteristics, consumer rosters, user specified preferences, client-side targeting decisions, search results, application usage behavior, or time or any combination thereof. The advertising can also be permission based, that is, the user of the mobile handheld device must authorize receipt of such advertising. This can be done by allowing the user of the mobile handheld device to opt-in (i.e., indicate that they do want advertising on the mobile handheld device by calling, filling out a form, pressing a button or sending a message from the mobile handheld device, etc.) or opt-out (i.e., indicate that they do not want advertising on the mobile handheld device by calling, filling out a form, pressing a button or sending a message from the mobile handheld device, etc.). Note that, in one embodiment, the advertising is not permission based, but is automatically delivered and/or displayed to users of certain mobile handheld devices and/or carriers. In some embodiments, software that communicates with the ad center service can be pre-loaded on the mobile handheld device before it is bought by a user of the mobile handheld device. All types of advertising can be delivered and/or displayed, including brand advertisers, brick and mortar marketers (e.g., with couponing), over the air transactions (e.g., games, ring tones, application downloads), public service announcements, etc. It should be noted that the content (e.g., advertising) can be sent to the mobile handheld devices utilizing any mobile handheld mechanism, including, but not limited to: over-the-air and/or a Wireless Application Protocol (WAP) downloading, sideloading (e.g., using a Subscriber Identity Mobile (SIM) card), bundling with another application, sending through a Systems Management Server (SMS), burning into a chipset, forwarding from another entity or person (e.g., using Bluetooth technology), or utilizing Binary Runtime Environment for Wireless (BREW), Java, Java Micro Edition (JME) (e.g., Blackberry, MIDP2, CLCD, CDC), Multimedia Messaging Service (MMS), FlashLite, Windows Mobile (e.g., PocketPC, SmartPhone), Palm OS, Symbian, iPhone, Linux, Android, Danger Hiptop Operating System, or Real-Time Operating Systems (RTOS) (e.g., REX RTOX). In addition, note that any combination of the above can also be used.

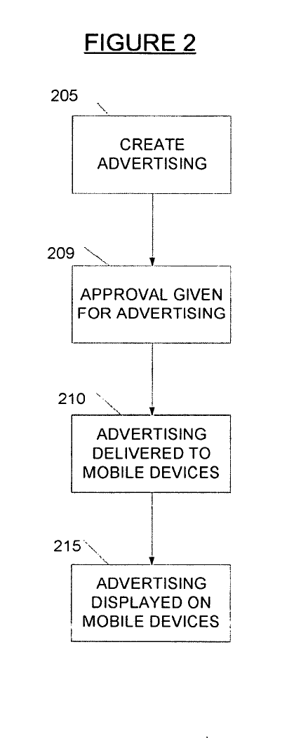

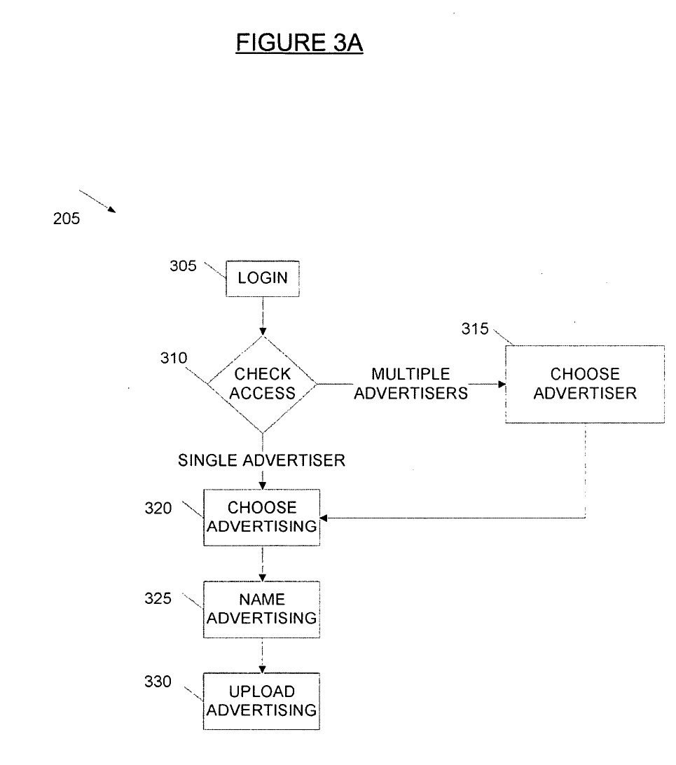

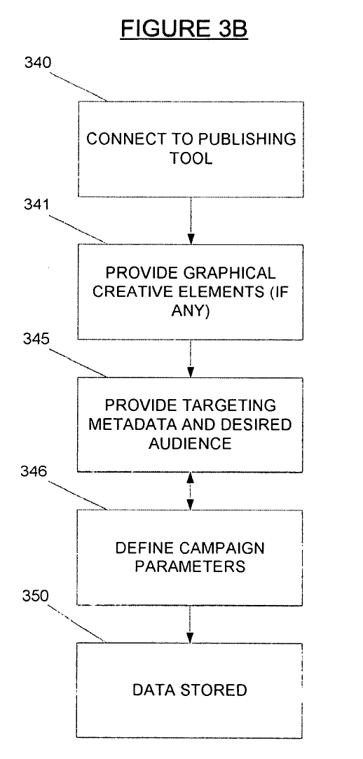

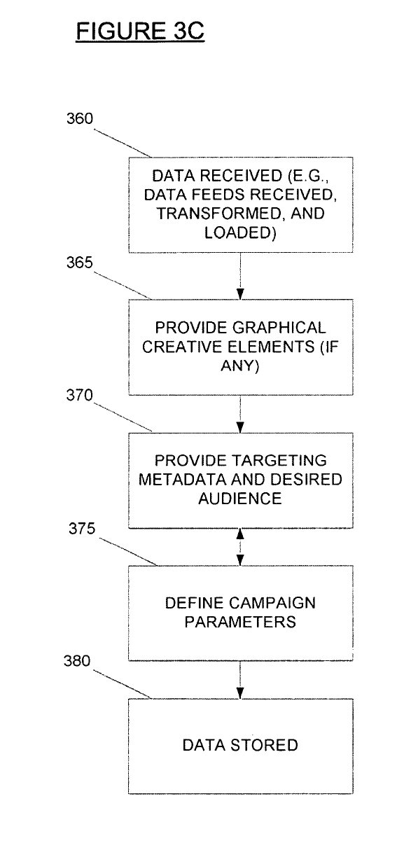

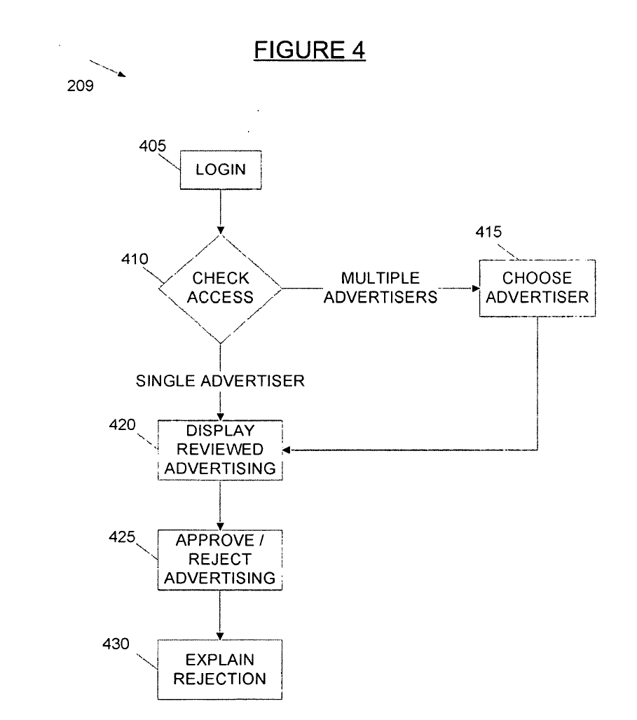

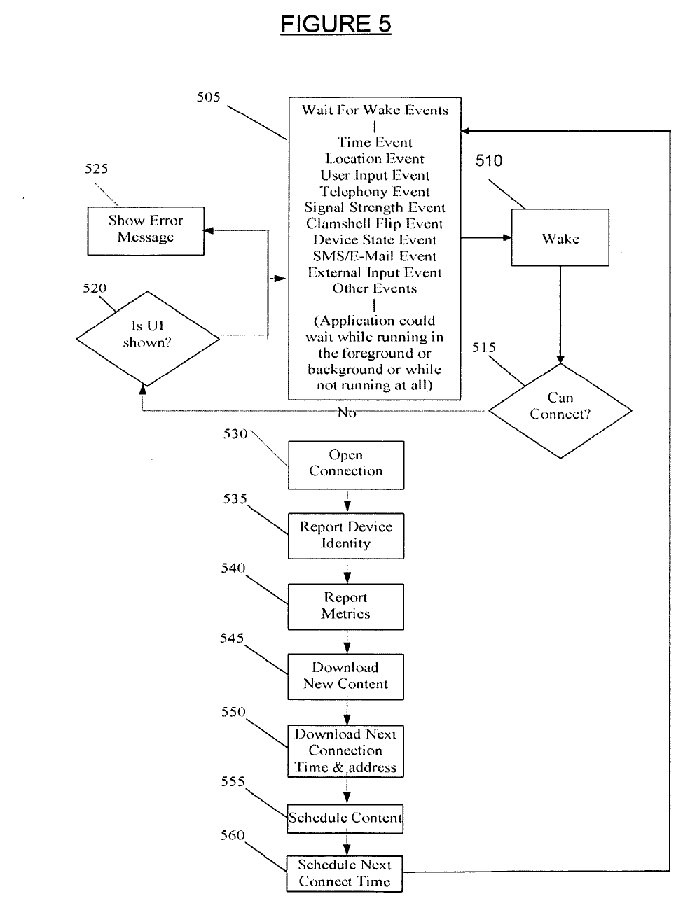

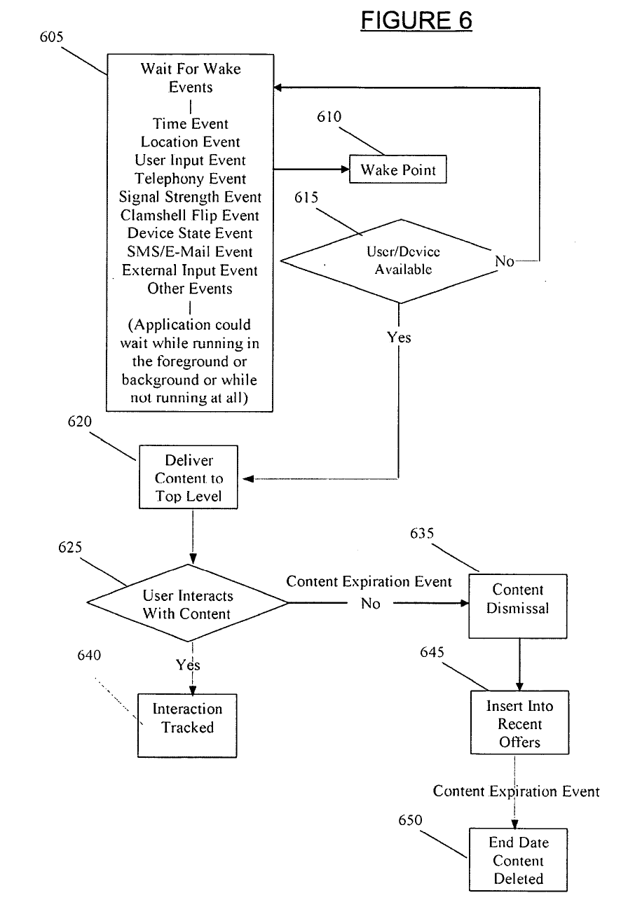

FIG. 2 illustrates a method for delivering and displaying content such as advertising to a mobile handheld device, according to one embodiment of the invention. In 205, the agency/advertiser creates advertising and submits the advertising to the ad center service (see FIGS. 3A, 3B and 3C for more details). In 209, approval is given for the advertising (see FIG. 4 for more details). This approval can be provided by different levels at the ad center service to ensure that, for example, the advertising is in a form that can be utilized by the system to send the advertising to the mobile handheld devices. This approval can also be provided by different levels at the carrier service so that, for example, advertising can be checked to see if it complies with company policies. This approval can also be provided by different levels within agency and/or advertising companies so that the agency and/or advertising companies can use the ad center service to internally approve advertising so that the advertising can be sent in a time effective manner (e.g., to improve its time to market). In 210, the advertising is delivered to the mobile handheld devices (see FIG. 5 for more details). In 215, the advertising is displayed on the mobile handheld device (see FIG. 6 for more details).

FIGS. 3A, 3B, and 3C illustrate methods of creating content such as advertising, according to several embodiments of the invention. Referring to FIG. 3A, in 305, a user logs in. In one embodiment, the user can be an agency/advertiser who has created their own advertising. In another embodiment, the user can be an administrator from the ad center service who has been tasked with creating advertising for a particular advertiser. In another embodiment, the user can be a carrier who is tasked with delivering advertising to the mobile handheld devices. In 310, access is checked (e.g., authenticated and authorized) to determine if the user that has logged in has access to the system. If multiple advertisers are available, an advertiser is chosen in 315, and the system proceeds to 320. In one embodiment, multiple advertisers can be available when an administrator of the ad center service has been tasked with creating or managing advertising for multiple advertisers. In addition, multiple advertisers can be available when an advertising agency is handling advertising for multiple clients. Multiple advertisers can also be available when a big company or entity with multiple brands needs to manage advertising for all of the brands, but wants the billing and/or tracking kept separate. Furthermore, multiple advertisers can be available when the user of the ad center service is a carrier who wishes to have access to all types of advertising that is going over the carrier's system. If only a single advertiser is available, the system proceeds to 320. In 320, particular advertising is chosen. In 325, the advertising chosen is named. In 330, the chosen advertising is uploaded to the system so that it is ready to be sent to the mobile handheld devices.

FIG. 3B illustrates a method of creating content utilizing a publishing tool portal, according to one embodiment. In 340, content providers or advertisers log in and/or connect to a publishing tool portal. Available space (i.e., unsold advertising real estate and related markets where an advertiser can insert ads) can be reviewed. In 341, advertising can be provided (or created or modified). An appropriate graphical template for the advertising or content can be chosen or uploaded. An appropriate text message for the advertising or content can be entered. The advertising or content can be assembled and previewed by the advertiser or content provider, and be edited as needed. In 345, the delivery and/or display criteria can be specified (e.g., user targeting criteria, dates, delivery caps). In 346, the campaign parameters can be defined. In 350, after the content or advertising is delivered, historical reporting data can be stored and provided upon request. In one embodiment, billing invoices can be created using the historical reporting data.

FIG. 3C illustrates a method of creating content utilizing a data feed, according to one embodiment. In 360, content (e.g., advertising, editorial data, weather, sports) can be received from an external source (e.g., via external files, RSS feed, XML data transferred over the Internet, or other sources can be accepted via an automated process). In 365, data can be validated and associated with appropriate elements (e.g., creative templates including graphics, logos, and other creative treatments). The resulting asset is transformed into a set of creative elements appropriately sized and formatted for the widest range of supported devices. In 370, targeting information and desired audience information can be provided. In 375, campaigns can be mapped to an appropriate audience. In 380, these elements are stored, along with relevant targeting and campaign information to drive subsequent targeting. The content distribution process leverages this data to route the most appropriate content to the right users and devices during this process.

FIG. 4 illustrates a method of approving content such as advertising, according to one embodiment of the invention. In 405, a user logs in. In one embodiment, the user can be an administrator from the ad center service who is tasked with approving the advertising. For example, the ad center service can check to make sure the advertising complies with technical requirements. In addition, in one embodiment, the user can be a carrier who approves the advertising. For example, the carrier can ensure that the advertising complies with company policies (e.g., policies not to show tobacco commercials, policies not to show competitor carrier commercials, etc.). In addition, the user can be an advertising company and/or agency that needs to have internal approvals of advertising before it is ready for the ad center service. In 410, access is checked to determine if the user that has logged in has access to the system. If multiple advertisers are available, an advertiser is chosen in 415, and the system proceeds to 420 If only a single advertiser is available, the system proceeds to 420. In 420, the advertising that needs to be approved is displayed. In 425, the advertising is approved or rejected. Thus, in one embodiment, the ad center service can approve or reject the advertising. In addition, in one embodiment, the carrier can approve or reject the advertising. In 430, if the advertising was rejected, an explanation of the rejection is provided to the ad center service so that the ad center will know the reason for the rejection. It should be noted that multiple approvals and multiple approvers can be utilized. For example, if an ad experience is being created for an advertiser, the advertiser may need to approve the user group or target group as well as go through a creative process of approvals which includes creating and editing proposed verbiage for an ad. This ad could have an internal review and approval process, and then have advertiser review and approval process. Each approval process could include multiple rounds of review.

FIG. 5 illustrates a method of loading content, such as advertising, on the mobile handheld device, according to an embodiment of the invention. This content can be customized to the users or mobile handheld devices based on various factors. One or more elements of the content can then be displayed on the mobile handheld device. The delivering of the content to the device, can be separate from the displaying of the content (as discussed more with respect to FIGS. 5 and 6), and can be displayed, for example, at a time subsequent to a session in which the content was delivered. Thus, for example, if a user is not available when the content is delivered, or if the optimal time for displaying the content is not when it was delivered, the content can be displayed later. In addition, various pieces of tracking, usage, user behavior, and other measured behaviors can be compiled and sent back to the host of the application (e.g., when the device next checks in with the host). These elements are discussed in more detail in the paragraphs that follow.

It should be noted that, in one embodiment, mobile handheld device application(s) required to display the advertising can be bundled with the mobile handheld device. In other embodiments, the application(s) required to display the advertising can be sent to the mobile handheld device (e.g., from a content provider, from an advertiser, from a current user of the application(s)). In addition, custom interfaces can be created. The interfaces may be simple or more complicated systems that allow new and unique interaction with the mobile handheld device.

Referring again to FIG. 5, in 505, the application on the device can wait passively for a wake event to initiate the download. It should be noted that waiting for the wake event to occur (as with many other steps in the embodiments described herein) is an optional feature, and not necessary in all embodiments. The wait process can occur while the application is not currently running, while the application is running in the foreground with a user interface (UI), or while the application is running (e.g., transparently) in the background with no UI. Wake events can include internal events, external events, and/or other events. Internal events include, but are not limited to: reception device events (e.g., a telephone call, browsing Internet, playing a game, taking a picture, listening to music, watching a video, inputting data, sending a message, composing a message, reading a message, utilizing navigation capabilities, utilizing another application), a time event (e.g., a scheduled time), a location event (e.g., when the device crosses a geographic boundary), a user input or interaction event (e.g., the user pressing a button, the user choosing a menu item), a telephony event (e.g., receiving an alert, an alarm going off, a meeting alert going off, putting in a calendar entry), a signal strength event, a movement of the device (e.g., a clamshell flip event (opening or closing of the device)) a power related event (e.g., when the battery reaches a certain threshold of battery remaining, a power on/off event such as something that initiates power getting to or being removed from the device), or an incoming/outgoing Short Message Service (SMS) or email, or any combination thereof. External events can include, but are not limited to: sound (e.g., a user talking to another person not using the mobile handheld device), motion (e.g., putting the mobile device against your ear, holding the device horizontally or vertically), an event (e.g., a news event, an emergency notification), a temperature where the mobile handheld device is located, a location where the mobile handheld device is located, a geographic profile of locations the user frequents, or an combination of such events. A power related event (e.g. when the battery reaches a certain threshold of battery remaining) or a power on/off event (e.g. something that initiates power getting to or being removed from the device.)

Combinations of wake events can include but not be limited to: a location event in conjunction with a time event (e.g., if the user crosses a boundary between 11 am and 1 pm); a signal strength event in conjunction with a time event (e.g., if the device acquires a strong signal between 11 am and 1 pm); a user input event in conjunction with a location and a time event (e.g., if the user enters input between 11 am and 1 pm and the user is located in a certain geographic area); a motion event in conjunction with a time event (e.g., putting the device against your ear between 11 am and 1 pm); a telephony event in conjunction with a time event (e.g., if a call ends between 11 am and 1 pm); a camera event in conjunction with a time event (e.g., if a picture is taken between 11 am and 1 pm); or a clamshell flip event in conjunction with a time event (e.g., the clamshell is flipped open between 11 am and 1 pm). Note that any combination of the above can also be utilized.

During a process of distributing the content to the devices, the distribution system makes a determination as to which specific creative elements are delivered to the device. The determination includes information about the physical device characteristics (e.g., whether the mobile handheld device has a camera or certain display capabilities) or characteristics of the user of the mobile handheld device (e.g., gender, marital status, past user behavior, personal preference options, location of the mobile handheld device) (either known or provided by the user). Based on the composite of this information, as well as thresholds established by specific campaigns, appropriate ads can be selected and delivered to the client using any combination of data and events.

In 510, the application on the device can awake in response to the wake event. If the application on the mobile handheld device is not currently running, it is invoked to a running state. The application on the device may instantiate a user interface, or it might run transparently in the background. In 515, it is determined if the mobile handheld device can connect to the service. If it can't connect to the service, and in 520 if a user interface is showing, in 525 an error message is displayed, and the process returns to 505 and repeats. If it can't connect to the service and in 520, if no user interface is showing, the process directly returns to 505 and repeats. If the mobile handheld device can connect to the service, in 530 the connection is opened. In some embodiments, if the mobile handheld device cannot connect, or properly identify itself (as explained below), an error message can be displayed. In 535, the mobile handheld device sends data to identify itself and can send an indication of its capabilities. The identity of the mobile handheld device is used for authentication and to ensure that the mobile handheld device is authorized to receive the content.

A mobile handheld device can be authorized to receive the content when consumers (e.g., users of the devices) register to receive the content and define the types of content they would like to receive and when they would like to receive it. A mobile handheld device that is not authorized to receive the content can receive content (e.g., content telling them how to install the application, terms of service agreement, etc.) indicating how to become authorized to receive the content (e.g., by sending a message from the device or pressing a key on the device). In one embodiment, consumers who choose to opt-in to the platform can receive an inducement, (e.g., free ring tones, weather reports, wallpapers, discounted monthly usage fees, phone subsidies beyond the subsidy provided for signing a new subscriber contract).

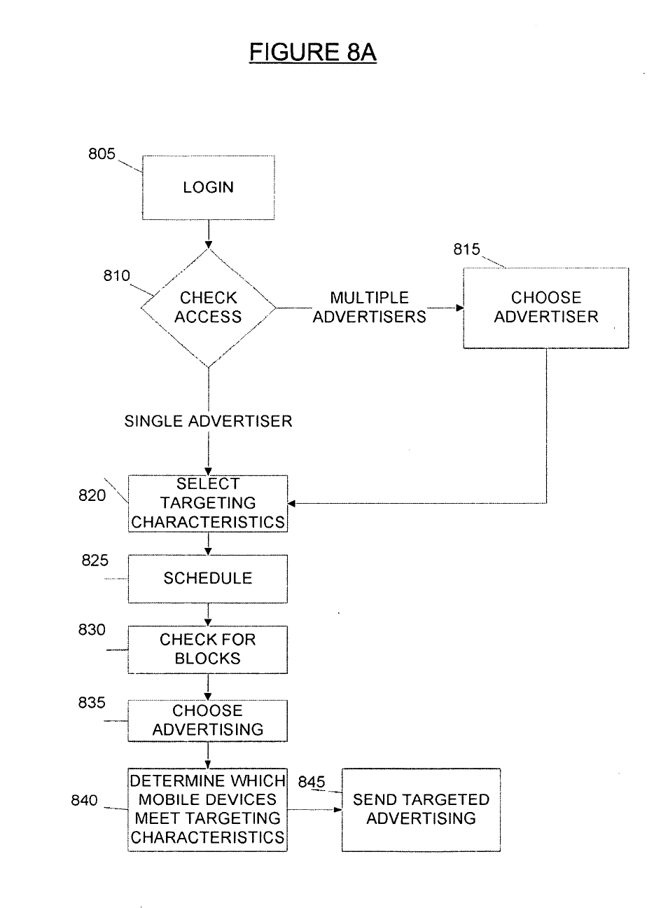

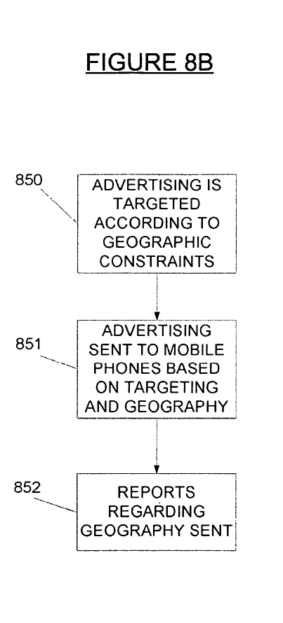

Within the consumer's parameters, the marketer can exercise control over which consumers receive content and can pinpoint delivery and/or display by targeting (explained below with respect to FIGS. 8A and 8B). Note that, however, in some embodiments, content is not targeted based on the consumer's parameters. The capabilities of the device are used to determine the types of content which will work best on the device.

In 540, the connection process is continued with the mobile handheld device sending report metrics which comprise, but are not limited to: an inventory of the content currently stored on the mobile handheld device, the duration of time spent on content and on content interaction (e.g., a Click to Call), the number of attempts to check-in, the amount of free memory on the device, the number of retry events, the number of times the device and/or application have been restarted, the signal strength of the device, the battery strength of the device, and metrics on the content click through. In 545, the content is downloaded to the device. In 550, the next connect time and the connection address to use, as well as other application and configuration data, are downloaded to the mobile handheld device. In 555, the application behavior is scheduled for action on the mobile handheld device. In 560, the next connect time is scheduled, and the process returns to 505 and repeats.

FIG. 6 illustrates a method of presenting content (e.g., advertising) on the mobile handheld device, according to one embodiment of the invention. In 605, the application on the reception device waits passively for a predetermined wake event or a combination of wake events, to initiate or activate an application which makes a determination of appropriate activity which may include displaying the content. It should be noted that waiting for the wake event to occur (as with many other steps in the embodiments described herein) is an optional feature, and not necessary in all embodiments. The wait process can occur while the application is not currently running, while it is running in the foreground with a user interface (UI), or while it is running transparently in the background with no UI. Wake events can include, but are not limited to, any external or internal event discussed with respect to FIG. 5 (or any combination of such events). The wake events can be designated by the content sent in FIG. 5. In 610, the application on the mobile handheld device awakes in response to the wake event in order to present the content.

In 615, in one embodiment, it is determined if the user and/or the mobile handheld device is available. In one embodiment, this is done so that the user of the mobile handheld device is not interrupted (e.g., in the middle of: a phone call, browsing the Internet, playing a game, taking a picture, using another application) by the content presentation. In other embodiments, the application might interrupt the user even if the mobile handheld device is determined to be busy. Certain real-time conditions could call for a revision of the delivery and/or display of the content and/or advertising. In the event of a time-sensitive event, such as a weather bulletin, Amber Alert, critical National News, or other time-sensitive content, content can be pushed to devices in close to real-time. In addition, external events, such as the user entering a geographic region, could trigger a high value delivery and/or display of location specific time-sensitive content, such as an offer to a nearby business. While the cost of delivery and/or display of these timely messages is likely to be higher, the value of the increased relevance should offset the additional costs. In such cases (e.g., time critical events, emergency events), the content can be displayed without checking to see if the user and/or the device is available, or regardless of whether the user and/or the device is available.

In 615, if the user and/or the mobile handheld device is not available, the process returns to 605 and repeats after waiting for a predetermined amount of time (e.g., 60 seconds), or in response to a wake event or set of wake events. If the user and/or the mobile handheld device is not busy, in 620, in one embodiment of the invention, the content is delivered to a foreground of a top level graphical user interface (GUI). In some embodiments, the content can be queued in the order it is to be displayed. In other embodiments, the content can be displayed according to any external or internal event discussed with respect to FIG. 5 (or any combination of such events). In some embodiments, a display duration designation can be set. This display duration designation can be changed (e.g., depending on how much the advertiser pays). FIG. 10 illustrates how the content or advertising can comprise a banner, which is presented on the foreground of the idle screen indicating there is a free fries offer at McDonalds.

In 625, if the user interacts with the application and chooses to get more information, a first screen showing more information on the offer is shown, and a second screen and subsequent screens may be shown. In addition, the user could be connected with sellers or content providers through one or more calls to action, which include, but are not limited to: going to a certain location (e.g., to use a coupon at dinner time), pulling additional information through data services (e.g., opening a browser session to a remote URL), placing a phone call (e.g., connecting to a contact center to complete a purchase via voice), completing a purchase and/or connecting via postal mail, snapping pictures or video, playing audio, displaying a recent offers or other offers list, opening a network connection to send and or receive data, SMS, and/or email from a remote source, opening a Bluetooth or Infrared connection, sending and/or receiving data, launching other applications, over-the-air installation of applications or data, purchasing of items (e.g., ring tones, applications, screen savers, wall papers), or any other action possible to do with the device. If the user does not interact with the device, the content can be dismissed in 635 after receiving a dismissal event. Dismissal events (or set of events) may include, but are not limited to, any of the internal or external events discussed with respect to FIG. 5 (or any combination of such events).

In 640, if the user has interacted with the application, this information can be tracked and sent as metrics to the host of the application running the content. Note that the interaction can be tracked by recording click-throughs (e.g. which screens of content were accessed by the user) and/or time spent on each screen, and/or by other methods.

In 645, content, whether or not displayed or interacted with, can be sent to a display area (e.g., recent offer display or other display area) to be presented as a choice to the user in a recent offer graphical user interface for subsequent display. Note that examples of recent offers and/or other offers are discussed, but that any recently sent content and/or other content could be stored in the display area. In one embodiment, different pricing options can apply—one price for content displayed on an idle screen, and one price for content sent directly to a recent offers and/or other offers display area. Content on the recent offers and/or other offers display area is presented to the user (and interacted within some embodiments) if the application is manually launched by the user. This recent offers and/or other offers display area can also be presented in response to delivered content. Content can have a predetermined expiration algorithm based on expiration events where, in 650, the content can be deleted from the device if it is determined to be expired. These expiration events (or set of events) can include, but are not limited to, any of the internal and external events set forth above in the explanation of FIG. 5 (or any combination of such events). Once an expiration event occurs, the content can be deleted from the device. It should also be noted that the user can save content in a “saved” section. In some embodiments, the user can choose which content is saved to this section, and when or if it is deleted. In other embodiments, there could be an expiration date (when appropriate) set on the ad/content that would allow it to automatically be removed from this storage area. In addition, the ads/content could be tagged in a special way that indicated they could be included in this “saved” section. In addition, reporting metrics could report that the user saved them in the “saved” section. The recent offers and/or other offers display area is an area where users can control different aspects of the display of the content. For example, instead of just being able to control the sound that happens when the banner appears, users could also control preferences about the content that is appearing in the recent offers and/or other offers display area, or even delete an item that is in the recent offers and/or other offers display area if they want it removed.

In addition, for appropriate content pieces such as a loyalty card (or credit card, or debit card, etc.), data (e.g., bar code image) of the loyalty card that is specific to the user could be stored and would allow the user to store many loyalty cards and transport them to other storage mechanisms as needed. For example, instead of carrying a gasoline loyalty card in a wallet or on a keychain, a user could carry it within an electronic storage mechanism in the mobile handheld device so that a retailer or other entity could scan the graphical representation of the loyalty card that is stored on the mobile handheld device.

Another possible embodiment would be a loyalty card (or credit card, or debit card) that expires after a certain number of uses. Data could be stored on the reception device, and the retailer, host, or other entity could “mark” the data to keep track of the number of times the card had been used. Once the card was “filled”, the user would be able to either present the filled card to the retailer or other entity and/or the retailer or other entity could send the user a special code for redemption.

It should be noted, that, in some embodiments, content can be dynamically resized by (e.g., by the host, the client, or the mobile handheld device itself) to suit the display needs of the target mobile handheld device. The host may choose to store a large master version of the content, which can be resized and re-oriented (e.g., portrait, landscape, font size) as needed before, during, or at the time of distribution. In addition, in one embodiment, the content can be formatted to take advantage of certain features available in certain mobile handheld devices (e.g., external screens (screens that are displayed when the device is closed), audio capabilities, flash of light capabilities, vibration capabilities). For example, when content is created it can be created at the highest possible resolution, and in an assortment of sizes, and form factors (e.g., square, portrait, landscape). In addition, the original textual representation of the ad creative can be maintained. A process can be employed where the server process identifies the recipient (mobile handheld device) of given content, both when this recipient is established and registered, as well as when the recipient is unregistered (e.g., the target of a “send to a friend”, or other content sharing activity). The request to the host uses a variety of information to profile the recipient's mobile handheld device, and select the highest possible resolution, and quality creative to deliver and/or display to the recipient. For example, when a low resolution or small screen device receives an ad, and forwards it to a friend with a better device, higher resolution content can be delivered and/or displayed to the friend. Similarly, a user with a large, high resolution screen, may share an ad with a friend with a very low resolution, or text only device. In this case, the best resolution for the low resolution device is able to be delivered and/or displayed on this friend's device.

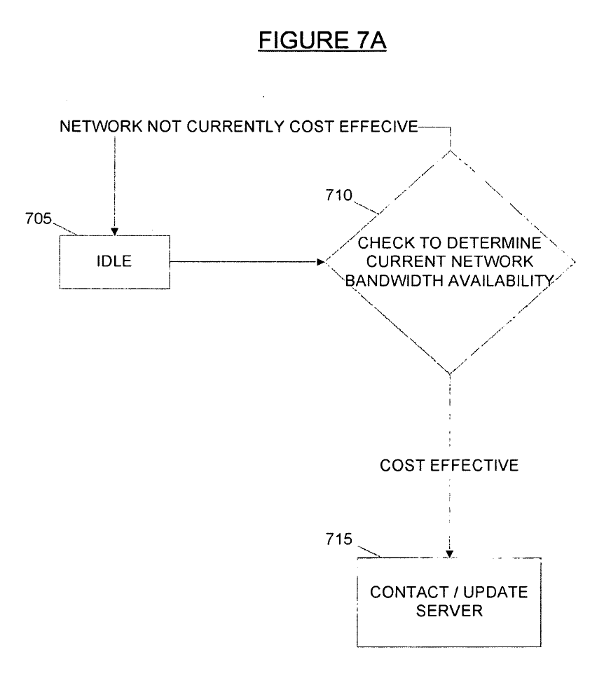

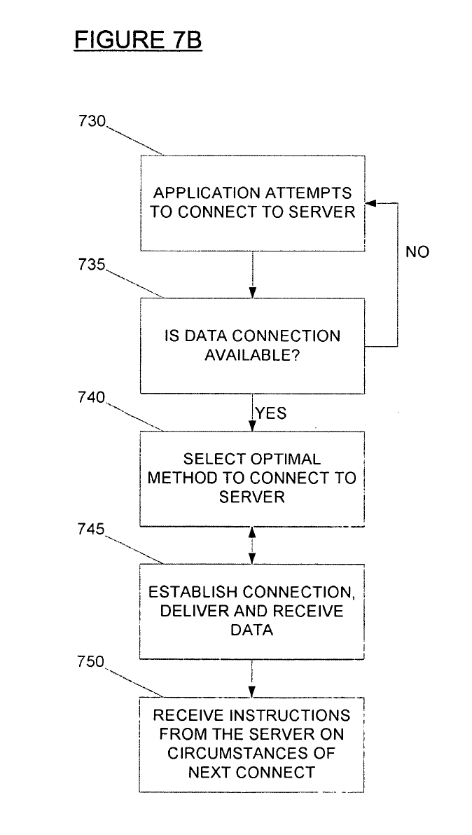

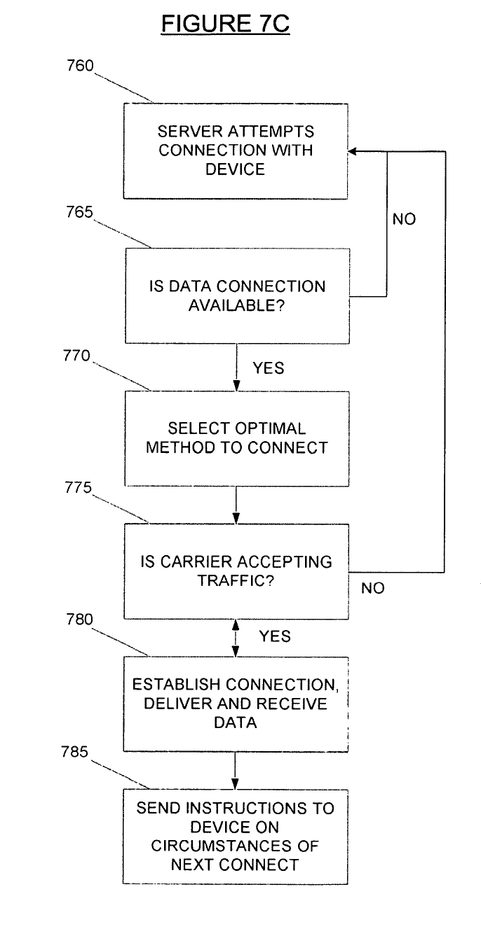

FIGS. 7A, 7B, and 7C illustrate methods of sending content to the mobile handheld devices. FIG. 7A illustrates a method of optimizing network use so that content such as advertising is sent during optimal or specified times, according to one embodiment of the invention. In 705, the mobile handheld device communication service is idle. In 710, the mobile handheld device communication service checks to determine current network bandwidth availability. If the network is not currently cost effective, the process returns to 705. If the network is currently cost effective, the ad center database is contacted and new advertising is sent to the mobile handheld device communication service so that the new advertising can be forwarded to the mobile handheld devices. In one embodiment, the advertising and/or the reporting metrics are sent only during optimal times when the network is not busy (e.g., at night). In another embodiment, the advertising and/or reporting metrics are sent at whatever time is best (e.g., real-time, dinner time to coincide with a coupon offer).

FIG. 7B illustrates a method where a mobile handheld device connects with a server, according to one embodiment. In 730, the application on the mobile handheld device attempts to connect with the server. For example, the mobile handheld device can initiate connection when it is scheduled to check-in, some wake event occurs (e.g., opening a clamshell, reaching a specified location, end of a phone call, other event); and/or as a result of a user request. In 735, it is determined if a data connection is available (e.g., is the phone in use). If not, the process moves back to 730 and the mobile handheld device attempts to connect again based on pre-set instructions. If yes, the process moves to 740, where an optimal method to connect and/or transmit to the server is selected (e.g., data connection over HTTP, SMS, MMS, connection via the device's browser). In 745, the connection is established, and the mobile handheld device receives the content from the server. If the mobile handheld device cannot initiate the connection, it can schedules itself for an additional connection attempt in the future. In 750, additional content from the server can be sent providing instructions on when the mobile handheld device should again attempt to contact the server.

FIG. 7C illustrates a method where a server connects with a mobile handheld device, according to one embodiment. In 760, the server attempts to connect with the mobile handheld device. This can be triggered because the server is scheduled to check-in, because of some external event (emergency alert, content update, additional content or offer needing to be sent to the phone, responding to an external request from a customer wanting to send the content). In 765, it is determined if a data connection is available (e.g., is the phone in use). If not, the process moves back to 760 and the server attempts to connect again based on pre-set instructions. If yes, the process moves to 770, where an optimal method to connect and/or transmit to the mobile handheld devices is selected (e.g., data connection over HTTP, SMS, MMS, connection via the device's browser). This optimal method can be chosen, for example, based on cost effectiveness, how clearly the data transmission will be, etc. In 775, it is determined if the carrier is accepting traffic. If not, the process returns to 760 and an additional connection attempt can be scheduled. If yes, in 780 the connection is established, and the server sends the content to the mobile handheld devices. In 785, additional content from the server can be sent providing instructions on when the mobile handheld device should attempt to contact the server.

FIG. 8A illustrates a method of targeting content such as advertising, according to one embodiment of the invention. In 805, a user logs in. In one embodiment, the user can be a content provider, such as, for example, an agency/advertiser who has created their own advertising. In another embodiment, the user can be an administrator from the ad center service who has been tasked with creating advertising on behalf of a particular advertiser. In 810, access is checked to determine if the user that has logged in has access to the system. If multiple advertisers are available, an advertiser is chosen in 815, and the system proceeds to 820. If only a single advertiser is available, in 820, targeting characteristics are selected by the agency/advertiser or by an administrator from the ad center service. Targeting characteristics can include, but are not limited to, geography, demographics, psychographics (personality characteristics and attitudes that affect a person's lifestyle and purchasing behavior), mobile handheld device characteristics, consumer rosters, user specified preferences, client-side targeting decisions, search results, application usage behavior, and time. In one embodiment, content such as advertising can be sent to consumers, which are targeted by the targeting characteristics. In another embodiment, consumers can request content from specific content providers (e.g., such as advertisers), specific products, and/or specific geographic categories through a registration process or a preference update process where users of the mobile handheld devices are able to communicate what they are interested in receiving. Targeting characteristics can include user-selected opt-in choices and preferences, as well as preferences inferred from user behavior over time and demographic information about the user. Targeting characteristics can also include the ability to target specific mobile handheld devices. This can be done so that formatting requirements (e.g., font size is chosen depending on screen size; whether or not a mobile handheld device supports video advertising, etc.) can be taken into account when deciding which form of content (e.g., advertising) will go to which mobile handheld devices. In 825, the content (e.g., advertising) is scheduled. Thus, for example, the advertising is scheduled to run between 7 and 9 PM. In 830, the scheduling is checked to ensure that no other content (e.g., advertising) is running at the same time. In 835, the advertising to run for the targeting is chosen. In one embodiment the logged in user can choose the advertising/content. In another embodiment the content can be automatically chosen by the system based on parameters or characteristics of the content. The advertising/content can be supplied directly to the users of the mobile handheld devices through a means provided on the mobile handheld device or through an alternative mechanism such as a web based interface. The user supplied content could be categorized and/or rated and the system could choose the appropriate content based on such information or randomly. An example could be pictures submitted in relation to a theme or contest. Another example could be the results of a poll or vote. In 840, the mobile handheld device inventory database is consulted by the ad center service to determine which mobile handheld devices have users that meet the targeting characteristics (i.e., targeted mobile handheld devices). In 845, the targeted content (e.g., advertising) is sent to the targeted mobile handheld devices. In one embodiment, targeting can also comprise capping, including, but not limited to: type capping, frequency capping, device capping, impression capping, action and/or conversion capping, or any combination thereof.

Capping can include type capping. Type capping is a process of managing and limiting the frequency of a specific user receiving a type of content (e.g., advertising) in a specified time frame. Generally, a type is a class of content (e.g., advertising) based on subject matter, such as “fast food”, “apparel”, “auto maintenance”, etc. For example, say the number of fast food advertising any one mobile handheld device user receives in any one day needs to be controlled. If the goal is to show a maximum of two fast food packages of advertising in a specific day, this type targeting information will be incorporated into the ad center service's targeting capability. When deciding what packages of advertising to send for a given mobile handheld device user, the following will be determined: the packages of advertising within the system that are available for delivery, and their scheduled times and other targeting characteristics. Potential packages of advertising available for delivery to that mobile handheld device user will be listed. After creating a list of potential packages of advertising, the list will be evaluated against capping. If more packages of advertising of a specific type are on the potential list than is the maximum for that user, packages of advertising in the type are excluded from the list until the target is reached, and then the packages of advertising remaining are scheduled for delivery. In one embodiment, determining which content (e.g., advertising) will be sent from a list can be done by determining which advertising was listed first and/or by determining which content (e.g., advertising) will maximize revenue and/or by matching user preferences.

Capping can also comprise frequency capping. Frequency capping is a process of managing and limiting the frequency of a specific user receiving advertising from a specific advertiser in a specified time frame. Take as an example the situation where there are two packages of advertising scheduled for a given day for McDonalds, one targeted to the morning and the other targeted towards the afternoon. If the frequency capping is limited to a mobile handheld device user seeing a maximum of one package of advertising from McDonalds per day, when the ad center service is selecting the packages of advertising to provide to the client, the system would develop its list of available packages of advertising for a particular user, similar to the type capping discussion above. Here, the list would be evaluated against an objective of limiting the per day McDonald's packages of advertising to one. Based on evaluating the other packages of advertising in the target list, their relative priority and appropriateness for that user, one of the two McDonalds packages of advertising would be eliminated from the target list and not shown to the user. In one embodiment, determining which packages are kept and which packages are eliminated is done according to which packages were scheduled first. In one embodiment, determining which content (e.g., advertising) will be sent from a list can be done by determining which advertising was listed first and/or by determining which content (e.g., advertising) will maximize revenue and/or by matching user preferences.

Another type of capping is device capping. Device capping is limiting the amount of content based on characteristics of the device (e.g., the amount of memory available on the device in which to store content). For example, if there were six ads to be delivered, and the device only had room for three, the first three could be delivered. In addition, if there were six ads to be delivered, and five utilized only small amounts of data, and one utilized a large amount of data, the five small data ads could be sent to the device.

Another type of capping is impression Capping. Impression capping is limiting the amount of content based on a predetermined amount of impressions or displays of a particular piece of content to a particular targeted group of devices. For example, an advertiser who has a preset budget can get a limited amount of impressions based upon that budget. As another example, if a certain amount of free t-shirts are available, impressions can be limited based upon the inventory of the give away.

Another type of capping is action and/or conversion capping. Action and/or conversion capping is limiting the amount of content available to a user and/or device based on reaching a certain threshold of actions or response (e.g., the number of “click to calls” placed, the number of users that registered or “opted in” as the result of a response to the content). The action and/or conversion capping can also be based on smaller segments within a targeted group of devices. For example, when a certain number of users from a particular demographic is reached, the action and/or conversion capping could then occur.

In one embodiment, capping can be managed across multiple days, managing and optimizing frequency of a particular advertiser's packages of advertising, or a total number of packages of advertising or types of advertising being shown across longer time periods, such as two days to a week.

In one embodiment, the targeting explained above allows advertisers and/or marketers to expand reach, effectiveness, and conversion rates by transforming the reception phone into a personal advertising medium that consumers want to use. They are able to achieve a personal and targeted connection with their customers and are able to reach an enormous audience.

In one embodiment, the targeting also allows carriers to access a new revenue stream, as they forward permission-based content. As explained above with respect to the approval process (FIG. 4), the carriers can also determine and control the quantity and type of offers that are served to subscribers.

In one embodiment, the targeting also provides consumers with a system that is free and easy to utilize. They are able to take advantage of unique and current offers on products and services that are targeted to them. Moreover, because the advertising is permission-based, and because customers are able to register for the advertising, customers can control the content and offers they receive. Thus, increased personalization, customization and convenience of advertising can be achieved. Consumers can save time and money and obtain access to exclusive offers and content that is not otherwise available.

In one embodiment, client-side targeting can be utilized. The data that is used to determine ad delivery could be sent to the client along with the ads themselves and the client could determine which ad should be shown.

FIG. 8B illustrates a method of geo-targeting content such as advertising, according to one embodiment of the invention. Context is important in advertising, and information regarding the right time and place to unite promotional messaging and potential customer need is helpful. In 850, the advertising is targeted based on the geographic reference points of the mobile handheld devices. In 851, the mobile handheld device communication service sends ads to the mobile handheld devices based on targeting and on the geographic reference points of the mobile handheld devices. This can be done in several ways. For example, in one embodiment, the geographic reference points of the mobile handheld device are sent to the mobile handheld device communication service, which makes a determination on which ads will go to the mobile handheld devices after it receives the geographic reference points. In another embodiment, the geographic reference points of interest are sent from the mobile handheld device communication service to the mobile handheld devices periodically. If the geographic reference points are reached, the mobile handheld device calls in to get the particular advertising from the mobile handheld device communication service. In an additional embodiment, the targeted advertising is sent with the geographic reference points from the mobile handheld device communication service to the mobile handheld devices nightly. If the mobile handheld device reaches the geographic points of interest, the ad center service delivers appropriate advertising to the mobile handheld device or the mobile handheld device determines appropriate advertising based upon criteria that have been delivered to the application.

In optional step 852, reports regarding the location of the mobile handheld devices are sent to the mobile handheld device communication service on a regular basis. These are in turn passed to the report center service for processing. This allows advertisers to change and update their advertising based on this location information.

FIG. 9A illustrates a method of forwarding content such as advertising, according as one embodiment of the invention. In FIG. 9A, a user of a mobile handheld device can indicate that content (e.g., advertising) should be sent to another person or a group of people at their receiving devices. In one embodiment, the user can enter the phone number, email address of the person(s) to whom the advertising is to be delivered, or any other unique identifier. This can be done, for example, by entering the phone number or email address from their mobile handheld device's keyboard or by selecting the number from their mobile handheld device's address book, buddy list, proximity information, “my favorites” list; speaking the name into the mobile handheld device; or any combination thereof. In 910, this request is sent to the ad center service.

In 915, the ad center service records information about the other receiving device(s). In 920, it is determined whether the receiving device has the appropriate software to show the advertising in its original form. If yes, the appropriate software is resident on the receiving device, the advertising is shown in its original form to the other person on their receiving device. If no, the kind of message to be delivered is determined based upon the target receiving device and the software that is available on the receiving device. In one embodiment, information can be included about who forwarded the advertising regardless of what form the advertising is shown in.

It should be noted that the request of 910 could also be a peer-to-peer request. In this case, when a user of the application receives content (e.g., an ad) that they would like to share with a friend, if the content is shareable (e.g., if the advertiser wishes the content to be shared), the user can send the content to another user. For example, User A (the one who has something to share) can send an offer to User B (the friend) letting User B know that they are sending something that is a great deal or exciting to share. In one embodiment, User A could acknowledge before sending the offer to User B that User B meets any necessary guidelines for sharing (e.g., is of an appropriate age); or User B could acknowledge that they meet or accept any guidelines before User B could see the offer. The server could keep track of the transaction, keep track of the acknowledgement by either side of the acceptance of the guidelines, ascertain knowledge about User B and their information (e.g., handset type, unique identifier, phone number), etc.

In addition, when User A sends the offer to User B, besides the acknowledgement of guidelines process, User B could have the options of: (a) getting the required software on their own device so they could receive additional content or (b) utilizing applications on their receiving device to display the offer (in this case, the content can be displayed in an optimal manner based on the capabilities of the device).

FIG. 9B illustrates a method of rating content such as advertising, according to one embodiment of the invention. In 940, the user of the mobile handheld device decides to rate the advertising. The content can be rated based upon any criteria including: a level of satisfaction; a level of timeliness of delivery; a level of value; a level of quality; a level of relevance; or a level of appropriateness; or any combination thereof. In 945, whether the user likes or dislikes the advertising is reported to the host. In 950, the user's consumer preferences can be updated based on the rating of the advertising.

FIG. 9C illustrates a method of reporting information related to the content such as advertising sent to the mobile handheld devices, according to one embodiment of the invention. In one embodiment, reporting can help marketers to set up, monitor, and adapt their marketing campaigns. Reporting can define and measure the effectiveness of the message contents, the applicable calls to action, the relevant broadcast areas, days, and times, and the relevant user characteristics. Both real-time and historical reporting tools can enable marketers to adapt their campaigns mid-stream and to analyze long-term trends and results. Reporting information can include any information gained or tracked from interaction asked or required from the user of the mobile handheld device. As discussed above, the interaction can include, but is not limited to: being connected through a telephone call to an entity related to the advertising, being connected through the Internet to a web site related to the advertising, and/or receiving a download related to the advertising. The download can include, but is not limited to: a ring tone for the mobile handheld device, a screen saver for the mobile handheld device, and/or a game for the mobile handheld device. The download could be delivered or a link could be delivered and/or displayed for the user to follow to obtain the download. Turning to FIG. 9C, in 960, advertising is presented to the users of the mobile handheld devices. In 965, the interaction of the advertising is measured. This can be done, for example, in two ways. First, in 975, the duration of the display of the content is recorded. Or, in 970, events and/or interactions related to the content are recorded. In 980, the set of interactions measured is uploaded to the mobile handheld device communication service, which forwards the information to the usage database and the reporting service.

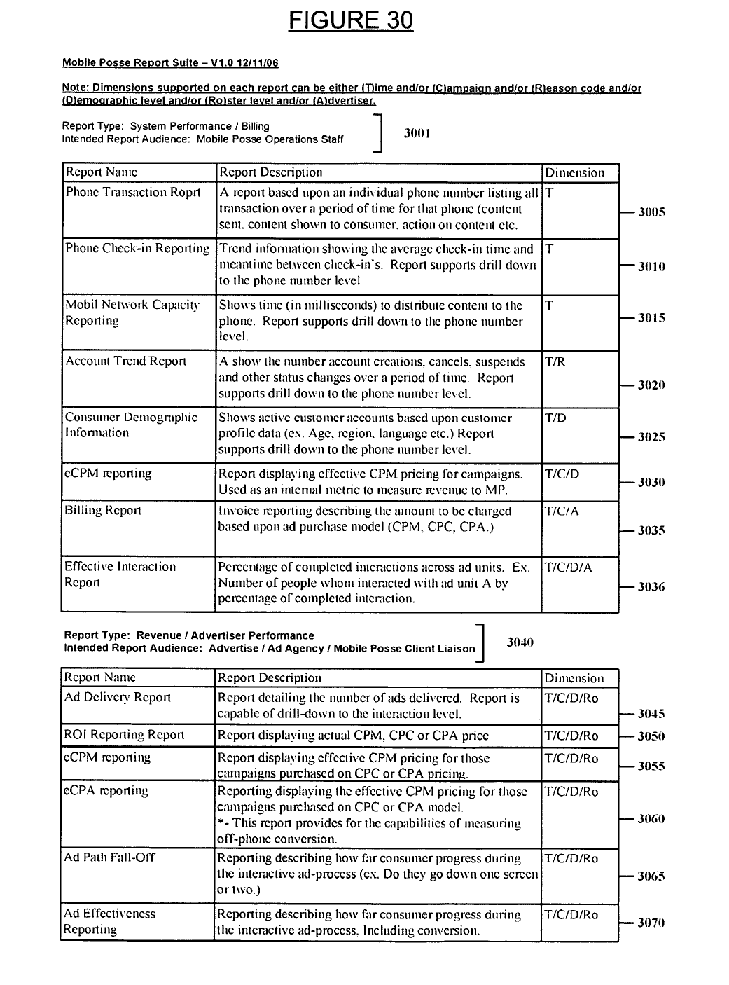

The reporting service compiles the information and makes available reports relating to the advertising to the agency/advertiser or other interested entity. Multiple types of reports can be generated. FIG. 30 provides a representative list of example reports. At the top of FIG. 30, sample system performance and/or billing reports 3001 are listed. These include, but are not limited to: phone transaction reports 3005, phone check-in reports 3010, mobile network capacity reports 3015, account trend reports 3020, consumer demographic information reports 3025, eCPM reports 3030, and billing reports 3035. Note that many of these reports can drill down to a unique identifier number (e.g., an account). Phone transaction reports 3005 are reports based upon an individual's account or a group of accounts in the aggregate, and list all transactions over a period of time for that account (e.g., content sent, content shown to consumer, actions on content). Phone check-in reports 3010 show trend information illustrating the average check-in time (i.e., how often the phone checks for advertising) and meantime between check-ins. Mobile network capacity reports 3015 show the time to distribute the advertising to the phone. The account trend report 3020 show the number of account creations (e.g., mobile handheld devices that are authorized to receive advertising), cancels, suspends, and other status changes over a period of time. The consumer demographic information report 3025 shows active customer accounts based upon customer profile data (e.g., age, region, language, etc.) The eCPM report 3030 displays effective pricing, such as cost per thousand (CPM), cost per click (CPC) and/or cost per action (CPA) pricing for campaigns. This report can be used as an internal metric to measure revenue. The billing report 3035 is an invoice report describing the amount to be charged to the advertiser/agency based upon the advertising purchase model (CPM, CPC, CPA). The effective interaction report 3036 is a report that provides information on interactions. For example, this report could tell an advertiser the number of people who interacted with the advertising. For example, if an advertiser purchased a 2-screen click-to-call advertisement, the effective interaction report would indicate that 2000 mobile handheld devices displayed the banner, 600 mobile handheld devices displayed interaction screen 1, 420 mobile handheld devices displayed interaction screen 1 and 2, and 300 mobile handheld devices utilized the click-to-call feature. In one embodiment, “advertising” shown is said to be the advertising displayed because advertising is only shown when the mobile handheld device is on and not otherwise being used. As indicated on FIG. 30, dimensions for each report are listed. T represents a time dimension, C represents a campaign dimension, R represents a reason dimension, D represents a demographic level dimension, Ro represents a roster level dimension, and A represents an advertiser dimension. The dimension column details under which constraints the reports can be viewed. Thus, for example, the billing report 3035 can be viewed under the T, C, and A dimensions. This means that billing information can be pulled for a particular time (T), for a particular campaign (C), and/or for a particular advertiser (A).

FIG. 30 also provides examples of revenue and/or advertiser performance reports 3040. These include, but are not limited to, delivery and/or display reports 3045, ROI reports 3050, eCPM reports 3055, eCPA reports 3060, path fall-off reports 3065, and effectiveness reports 3070. The delivery report 3045 details the number of ads delivered and/or displayed. This report can drill down to the interaction level. The return on investment (ROI) report 3050 displays actual CPM, CPC or CPA. The eCPM report 3055 displays effective CPM for campaigns purchased on CPC or CPA. The eCPA report 3060 displays effective CPA for campaigns purchased on CPC or CPA models. This report can measure off-phone conversion (i.e., how much and which of the advertising led to actual sales). In one embodiment, this could measure electronic conversion (e.g., buying a product through a web browser on the mobile handheld device). In another embodiment, this could measure conversions that occur outside the tracking ability of the electronic mobile handheld device (e.g., a user buys something online, or in a store, and received feedback on this transaction is utilized for reporting purposes). The path fall-off report 3065 describes how much consumer progress is made during the interactive process (e.g., does the consumer progress through one or two screens of the ad). The effectiveness reporting 3070 describes how much consumer progress is made during the interactive process, including conversion (i.e., how much and which of the advertising led to actual sales). Some advertisers like to know the actual cost of acquiring a subscriber. This cost is determined by taking the cost of the advertising and dividing it by the number of people that purchased the service because of that advertising. In addition, some advertisers would be interested to know that the click response to the initial advertising was very good, but that the conversion rate was still very low (e.g., the content is popular, but it doesn't induce people to buy the product, the advertising was misleading or not relevant, etc.) The report information can also measure the time when the content was displayed on the device, or when the device was in use in response to a Click to Action (e.g., a Click to Call).

FIG. 9D illustrates a method of searching for information using a mobile handheld device, according to one embodiment of the invention.

Referring to FIG. 9D, in 981, the consumer interacts with the mobile handheld device. In one embodiment, the user accesses a search icon. In another embodiment, the user of the mobile handheld device merely turns on the mobile handheld device or touches a key of the mobile handheld device and the search box appears.

In 982, the search box is displayed. When utilizing a mobile handheld device, a “search box” can be accessible on a top level user interface (e.g., an idle screen) of the mobile handheld device. Users of the mobile handheld devices are able to enter key words (e.g., by keypad or through speech), Boolean statements and/or similar search criteria to locate web pages (e.g., WAP pages) and/or other content and/or offers. In 983, the consumer interacts with the search box by entering a key word or informational search term by any means. In 984, the search service determines whether the search criteria are informational terms recognized by the search service. Thus, for example, if “weather” were entered as the search criteria, the search service would search to determine if “weather” was an informational search term. This could be done, by example, by searching a search database to see if the search criteria matched or closely resembled an informational term in the search database. If yes, in 985, the informational search term is captured by the search service so it can use it for future targeting. In 986, the informational search term accesses the search database to get the information corresponding to the informational search term. Thus, if “weather” was found to be an informational search term, then information related to the informational search term “weather” would be obtained from the search database. In 987, the information corresponding to the informational search term is sent back to the mobile handheld device, and is displayed on a top level interface of the mobile handheld device. Thus, weather information and optional advertising (e.g., to help compensate for the cost of providing the weather information) is sent back to the mobile handheld device and is displayed on the top level user interface. In another embodiment, if the user were to search for “pizza” a search would be performed for matching offers in their area and the most appropriate offers would be displayed.

It should be noted that, in one embodiment, the information corresponding to the informational search term can be targeted to the user. Thus, for example, the user could get weather information corresponding to the area code of his telephone or the location of the mobile handheld device when he makes the request for weather information or other information on file.

If the search service determines that the search criteria is not an informational term recognized by the search service (e.g., if the search criteria is “red roses”), in 988, if available, a browser for the Internet is opened (e.g., a WAP browser). In 989, the search criteria are also sent to the search service so that it can record the search request for future targeting. In 990, the consumer is directed to a search engine (e.g., a WAP search engine) to obtain the results corresponding to the search criteria. In 991, the search results and optional advertising (e.g., to help compensate for the cost of providing the results) is sent back to the mobile handheld device and is displayed on the top level user interface (e.g., the idle screen).

It should be noted that in additional embodiments, a context based search can be done based on current ads and/or by searching a recent offers and/or other offers list or section.

In addition, when invoked by an appropriate user action, the search capability can automatically identify suitable relevant content, and display this content to the user. Appropriate user actions include, but are not limited to: user invoking searches deliberately through a button, menu, or other user interface artifact, or as an automatic action tied to a user's activity with the device (e.g., typing content into a text message, taking a photograph, speaking, moving in or out of a specific geographic region, or another actionable change in the device's state.)

Furthermore, in some embodiments, all searches can be tracked and reports generated.

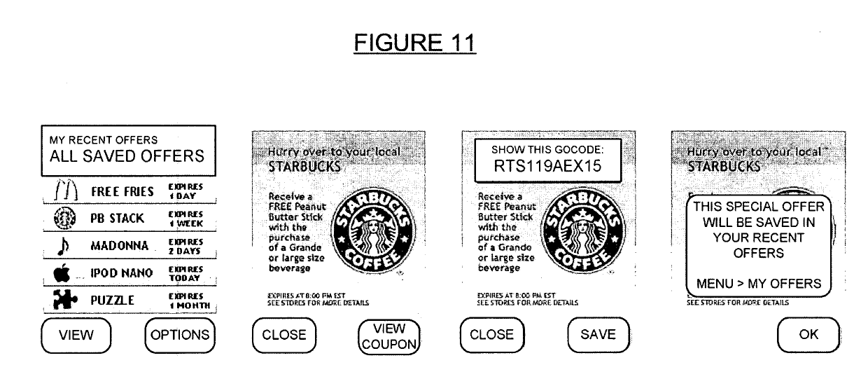

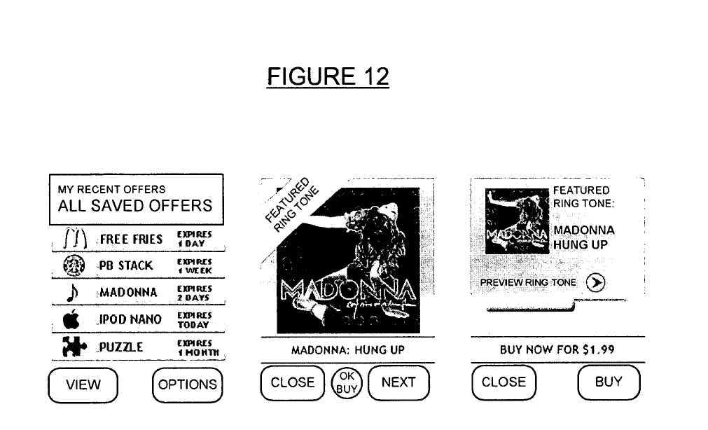

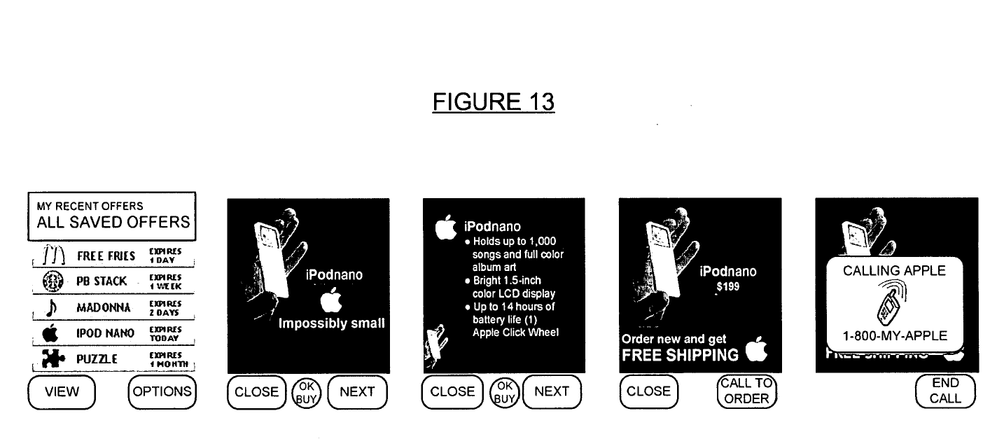

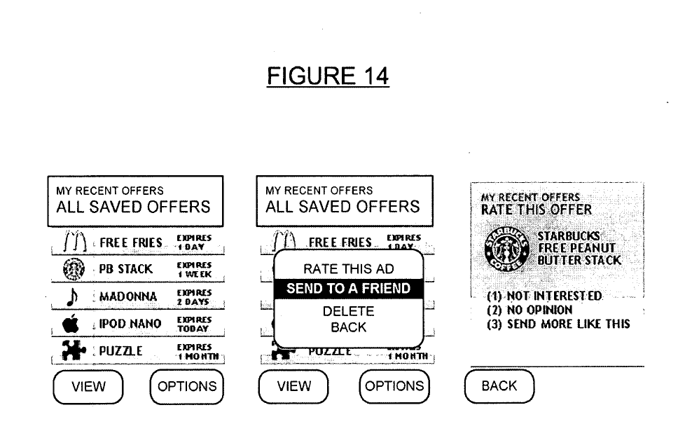

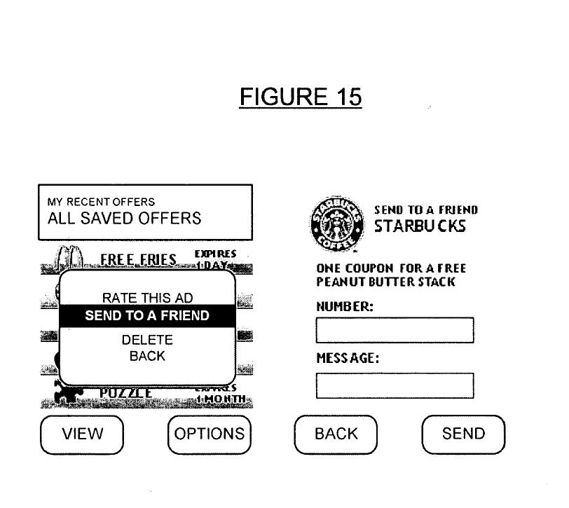

FIGS. 10-15 are example advertisements, according to several embodiments of the invention.

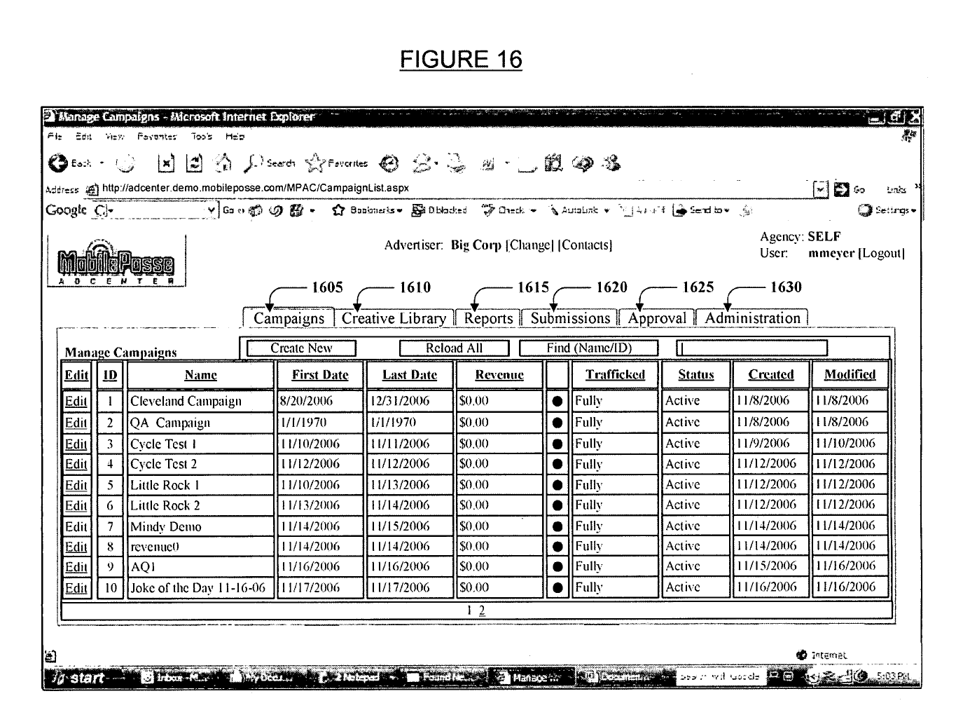

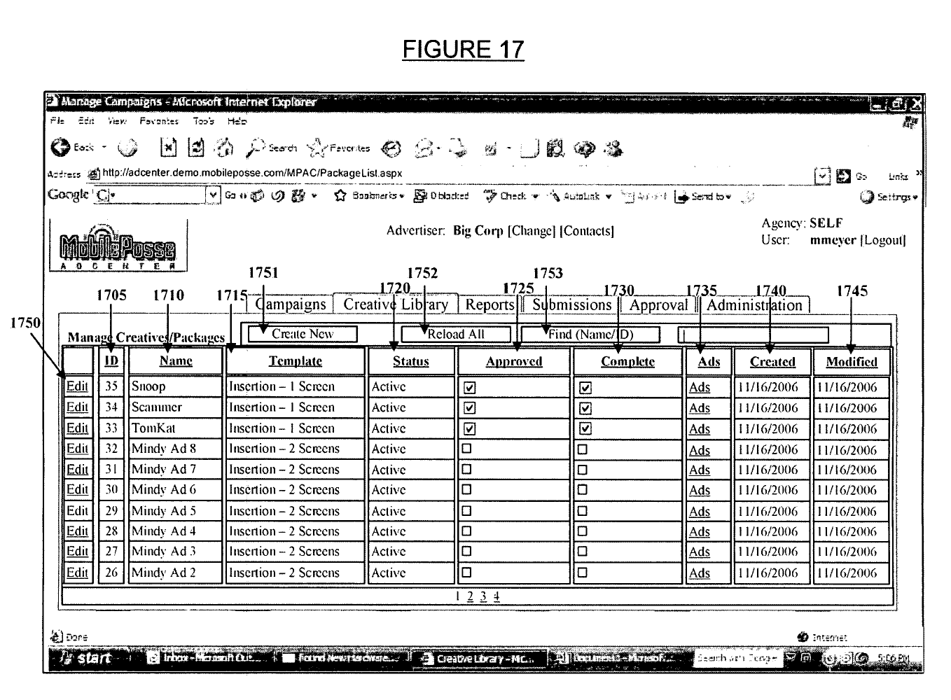

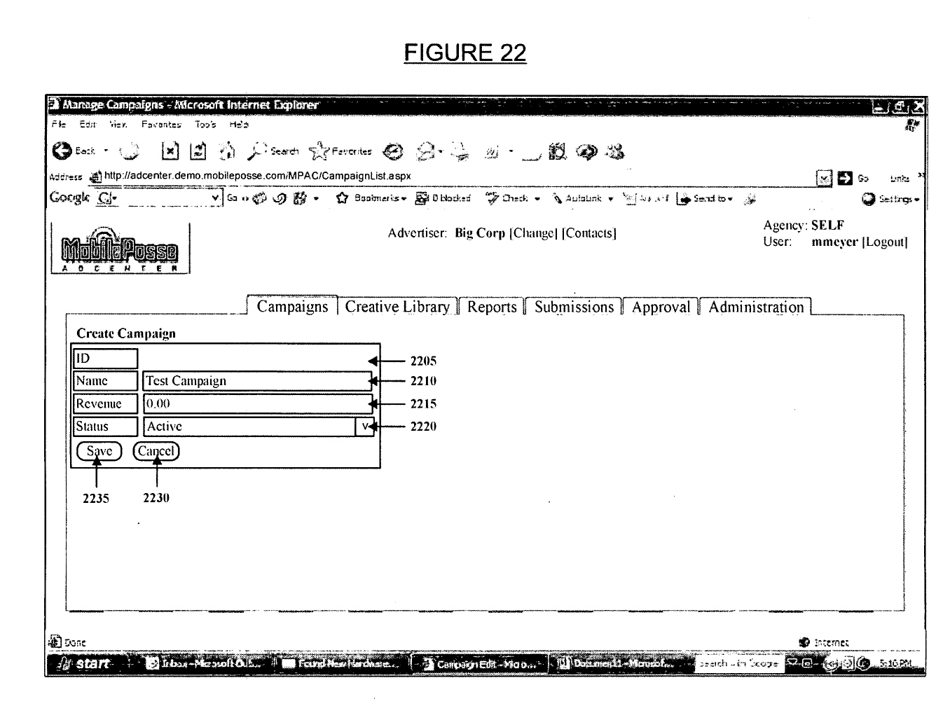

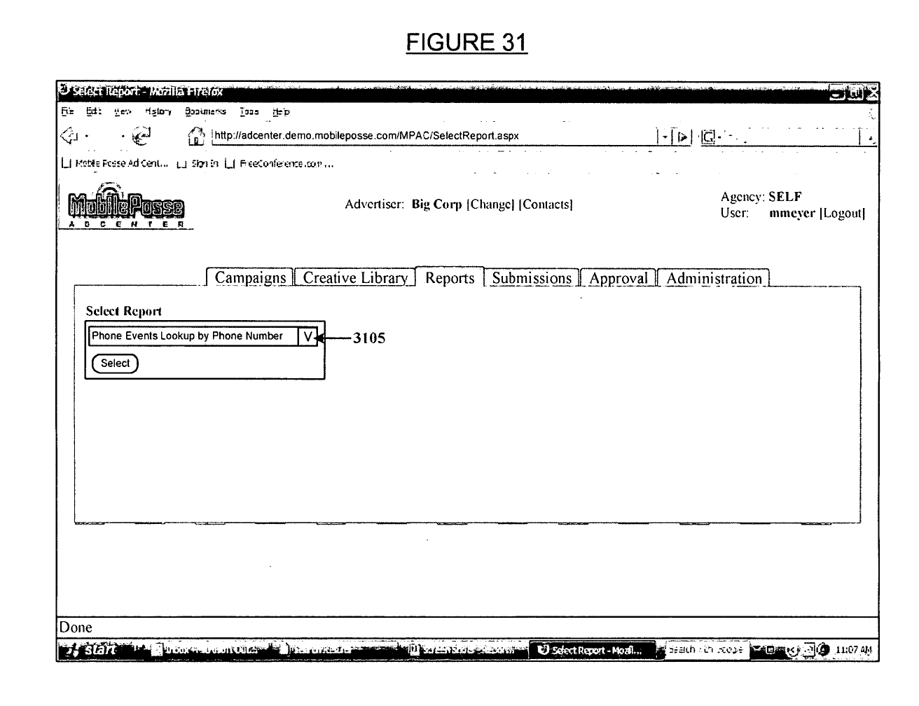

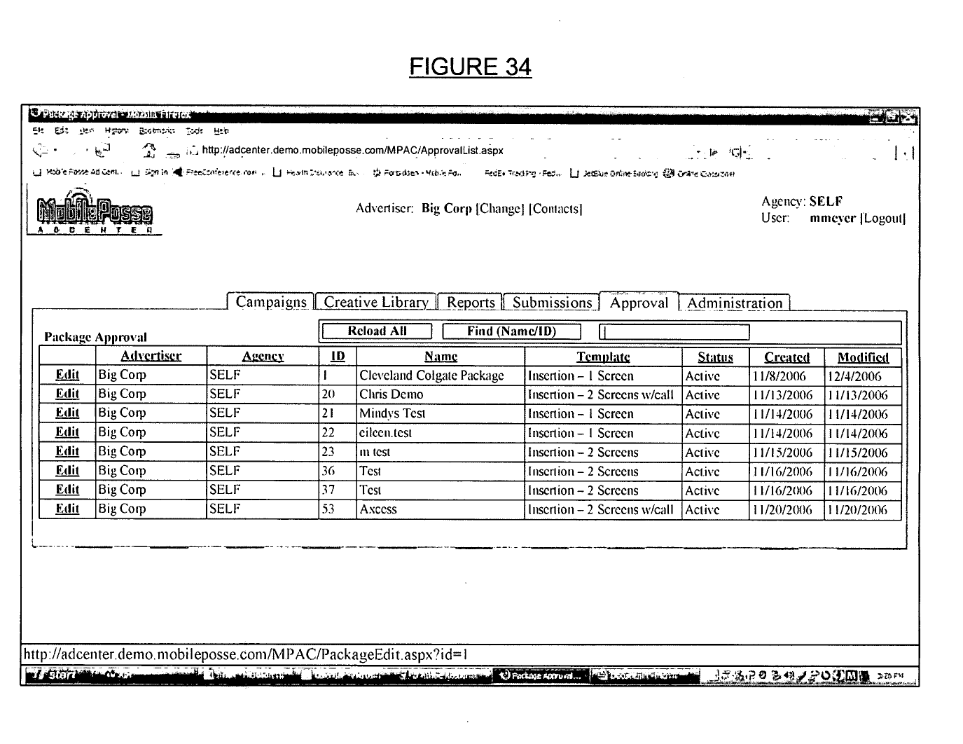

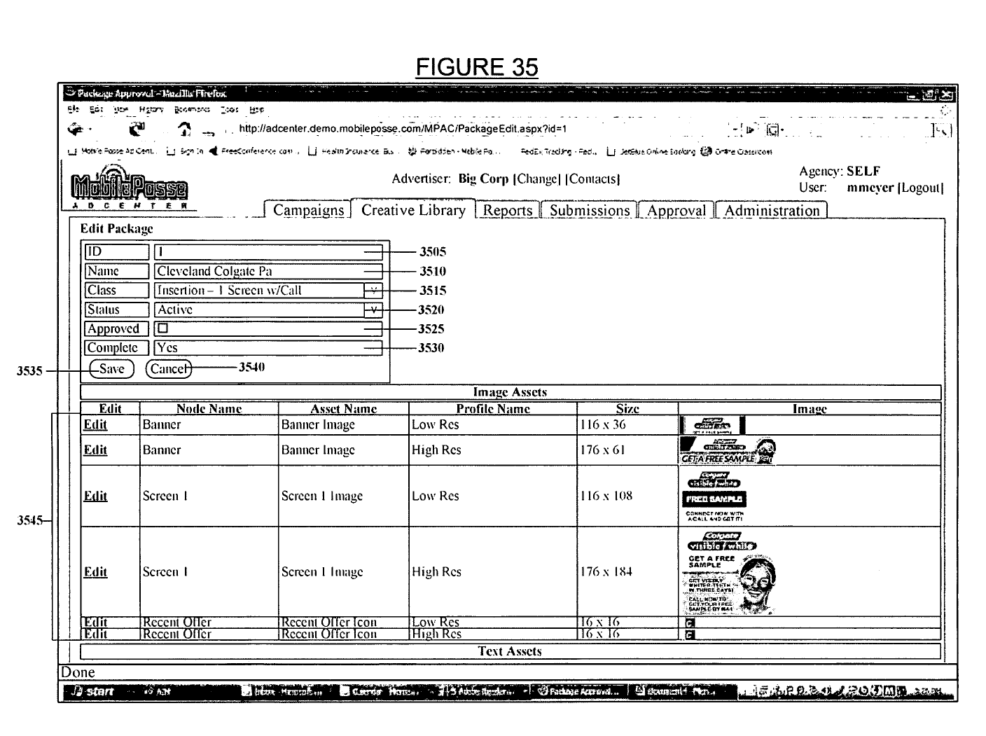

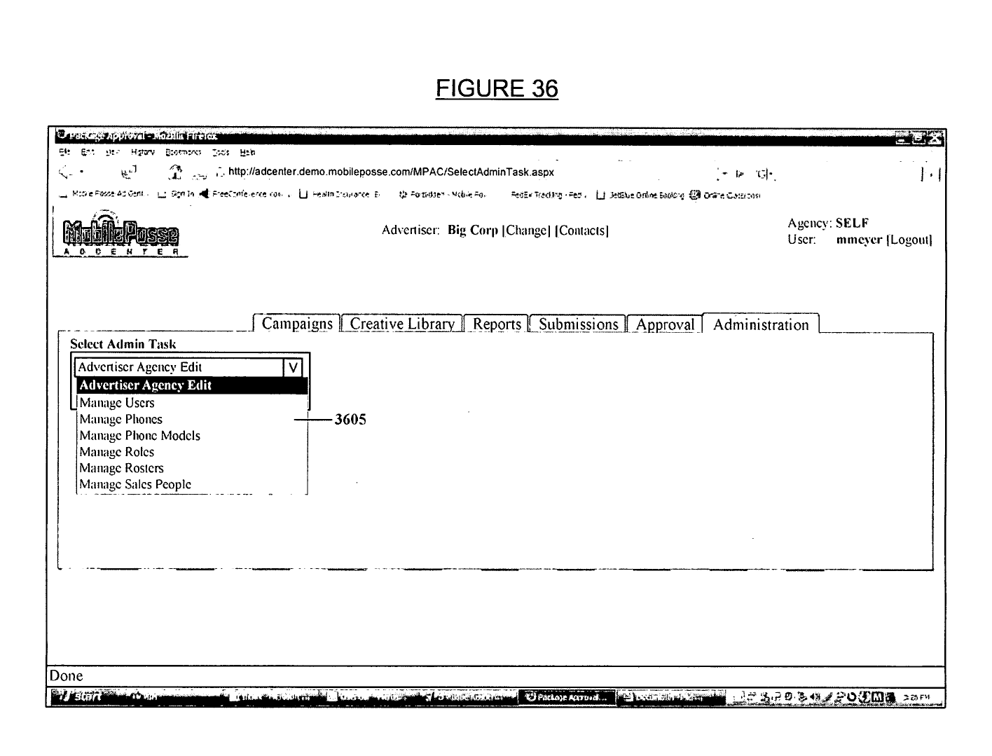

FIGS. 16-49 are sample screen shots illustrating how content such as advertising could be created and trafficked. FIG. 16 is a screen shot from the ad center service illustrating several options utilized in creating and managing advertising: campaigns tab 1605, creative library tab 1610, reports tab 1615, submissions tab 1620, approval tab 1625, and administration tab 1630. The campaigns tab 1605 allows the campaigns to be managed. As indicated earlier, a campaign is a collection of one or more packages for a particular advertiser, to be delivered and/or displayed over a specific period of time with an overall delivery and/or display goal (e.g., number of impressions, click through rate, etc.) and cost (e.g., revenue) and within certain capping criteria. A package is a collection of one or more creatives (e.g., images, videos, coupons, text, ring tones, wall paper, etc.), actions (telephone numbers, URLs, etc.), and a set of navigation/execution instruction to be delivered to a mobile handheld device and executed by a custom mobile handheld device application. A campaign presents the product or offering in different ways, presented to different people, presented in different places, and/or at different times. The options related to campaigns are described in more detail below in FIG. 16, and FIGS. 22-30. The creative library tab 1610 allows the creatives or ads to be managed. The options related to the creatives are described in more detail below in FIGS. 17-20. The reports tab 1615 allows reports to be generated. The options related to reports are described in more detail below in FIGS. 31-33. The submissions tab 1620 allows submissions that need to be reviewed by others to be put on the ad center service so that other entities can review and approve them in a centralized manner and place. The approval tab 1625 allows submissions to be approved in the ad center service. The options related to approvals are described in more detail below in FIGS. 34-35. The administration tab 1630 provides various ways of managing information about various users, mobile handheld devices, personnel, etc. The options related to administration are described in more detail below in FIGS. 36-49. Each of these options will be discussed in more detail below.

FIG. 17 is a screen shot in the ad center service illustrating details of the creative library tab 1610. As noted earlier, a creative is, for example, an image, video, coupon, text, ring tone, wall paper, used in a package for advertising. As shown on FIG. 17, an ID number 1705 is given to each creative. A name 1710 is also given to each creative. A template column 1710 describes the particular format of the creative (e.g., banner (initial advertising screen), 1 screen, 2 screens, call to action (e.g., click to call, click for information), etc.) The status column 1720 indicates whether the creative is active. For example, if a creative is active, it is able to be used. If a creative is inactive, it is not able to be used. If a creative is deleted, it has been removed. The approved column 1725 and complete column 1730 allow the progress of the creatives to be tracked. Thus, whether or not a creative has been approved can be tracked using these options. The ads column 1735 allows the creative to be viewed. The created column 1740 and modified column 1745 allow the date the advertising was created and when it was last modified to be stored. The edit command 1750 allows the advertising to be edited. The create new advertising button 1751 allows a new creative to be created. The reload all button 1752 allows all creatives to be reloaded. The find button 1753 allows advertising to be found utilizing the name or ID number. Thus, if a creative is saved after editing, it is added to the creatives list. If the change to the creative is cancelled after editing, the creative remains unchanged.

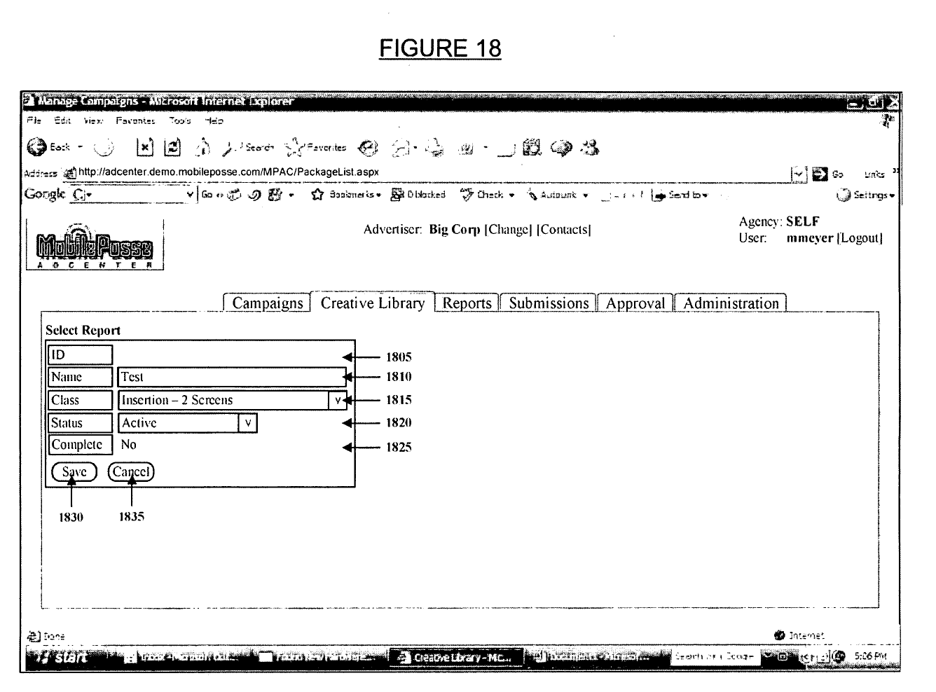

FIG. 18 is a screen shot in the ad center service illustrating details of the creating a creative button 1751. The ID number 1805 is assigned to the creative. The name 1810 allows the user to name the creative. The class 1815 describes the particular format of the creative. For example, the creative can be an insertion comprising one or more screens. The creative can also be of an interactive class. For example, the creative can allow the user of the mobile handheld device to click to call someone or be connected on the Internet to a web page for more information about something. As another example, the creative can allow the user of the mobile handheld device to opt-in, or just press a button that indicates that it is permissive for something to happen (e.g., make a purchase, download software, etc.) The status 1820 allows the user to designate whether the creative is active or not. The complete 1825 allows the user to designate whether the creative is complete or not.

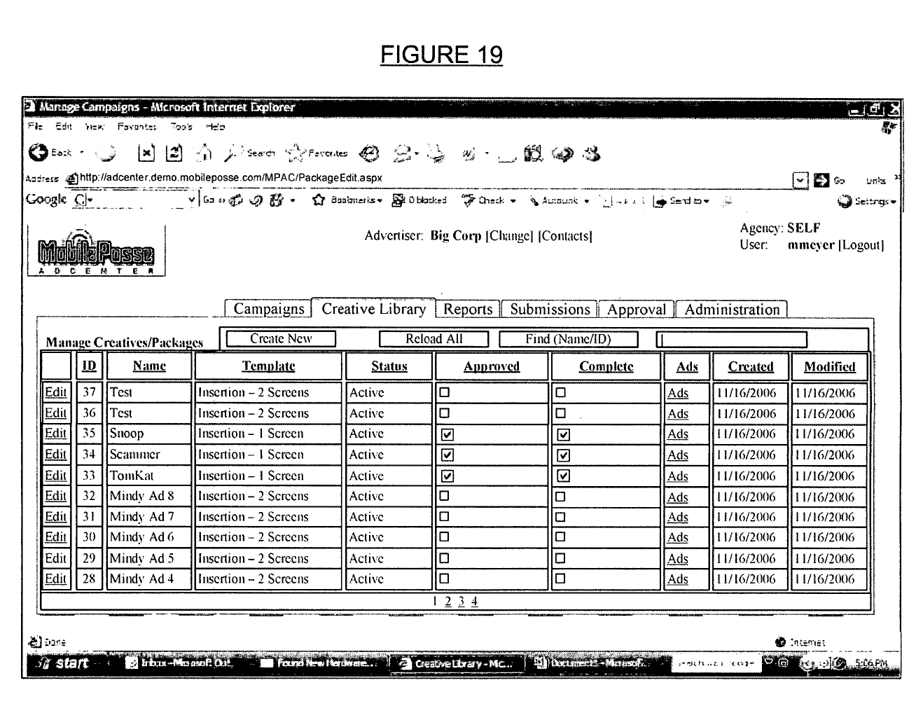

FIG. 19 is a screen shot in the ad center service illustrating how the creative library tab 1610 appears once the new creative discussed in FIG. 18 has been saved and added. Thus, if a user of the ad center service saves the package entitled “test” that it created in FIG. 18, it is added to the top of the list of creatives in FIG. 19. (Compare this with the list of creatives in FIG. 17.)

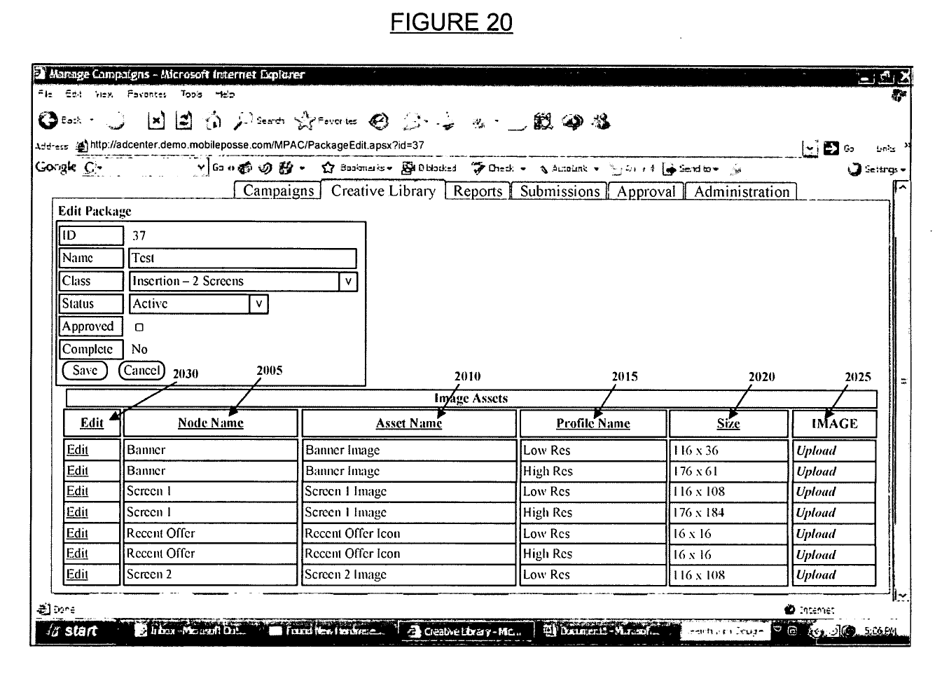

FIG. 20 is a screen shot in the ad center service illustrating details of the edit creative tab 1750. The node name 2005 indicates what type of advertising the creative is. The asset name 2010 indicates what type of image the creative is. The profile name 2015 indicates the resolution of the creative. The image 2025 allows the user to view the creative. The edit 2030 allows the user to edit the creative.

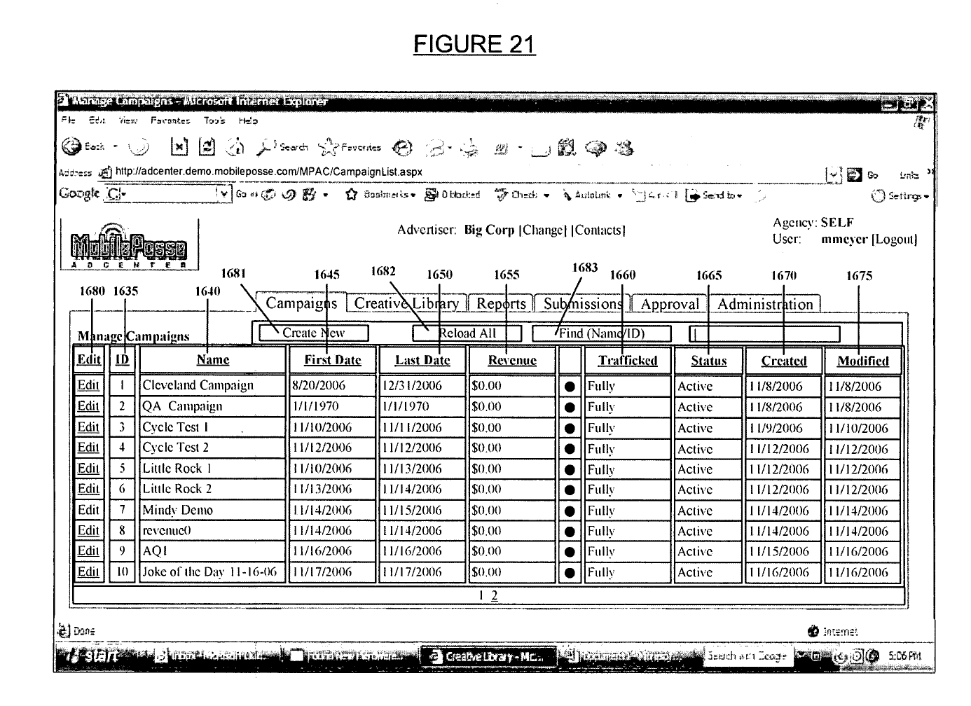

FIG. 21 illustrates details of the campaigns tab 1605. As shown on FIG. 21, an ID number 1635 is given to each campaign. A name 1640 is also given to each campaign. A first date column 1645 and last date column 1650 are also provided, which allows the first and last dates the campaign is to be shown to be indicated. The revenue 1655 generated from the campaign is also tracked. A trafficked column 1660 indicates whether a campaign is ready to be viewed by a user of a mobile handheld device (e.g., fully ready). For example, a campaign can be ready when formatting, timing, and slotting has been designated. In addition, the status column 1665 indicates whether the campaign is active, inactive, deleted, etc. For example, if a campaign is active, it is able to be used. If a campaign is inactive, it is not able to be used. If a campaign is deleted, it has been removed. The created column 1670 and modified column 1675 allow the date the campaign was created and when it was last modified to be stored. The edit column 1680 allows the campaign to be edited. The create new column 1681 allows a new campaign to be created. The reload all column 1682 allows all campaigns to be reloaded (i.e., listed on the campaigns page). The find button 1683 allows a campaign to be found utilizing the name or ID number.

FIG. 22 is a screen shot in the ad center service illustrating details of the create campaign button 1681. As noted above, a campaign has one or more creatives. As shown on FIG. 22, an ID number 2205 is given to each campaign. A name 2210 is also given to each campaign. A revenue cap 2215 describes the rule set for the particular campaign. For example, this can ensure that more ads will not be sent than the advertiser is willing to pay for. If the advertiser agrees to pay $30,000 for 900,000 targeted packages of advertising, the ad center service will only have the mobile handheld device communication service send 900,000 packages of advertising, even if there are 1,200,000 users of the mobile handheld devices that meet the constraints for the targeted advertising. The status 2220 allows the user to designate whether or not the campaign is active. The save 2225 and cancel 2230 buttons allow the creative to be saved or cancelled.

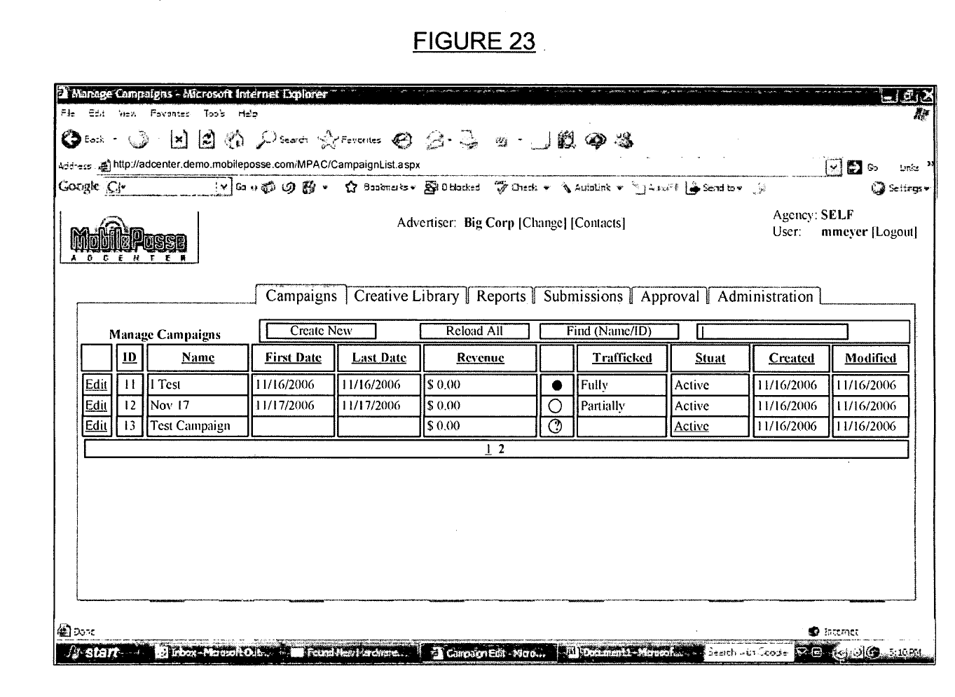

FIG. 23 is a screen shot in the ad center service illustrating details of managed campaigns. A list of campaigns is shown.

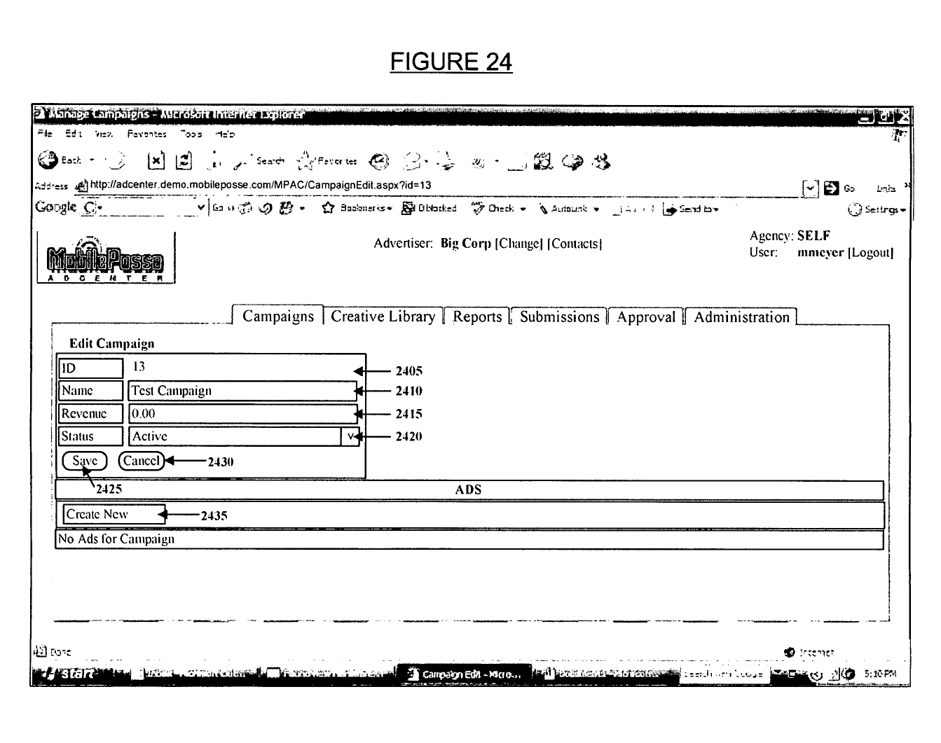

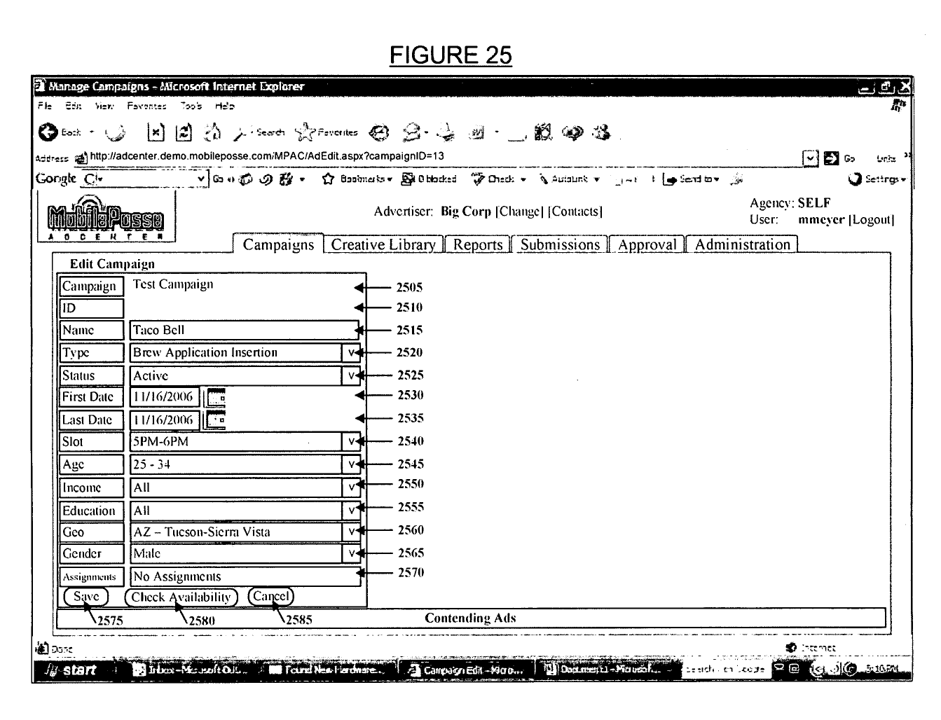

FIG. 24 is a screen shot in the ad center service illustrating details provided by clicking the edit campaign button 1680. The edit campaign option allows a user of the ad center service to edit a campaign that has already been created. The ID 2405 is the identification assigned to the campaign. The name 2410 is the name chosen for the campaign. The revenue 2415 is the capped revenue determined by the advertiser. The status 2420 designates whether or not the campaign is active. The save 2425 or cancel 2430 buttons allow the user to save or cancel the campaign. The list of ads 2435 indicates which ads (i.e., creatives) are to be utilized in this particular campaign. FIG. 25 is a screen shot in the ad center service illustrating the details provided by the create advertising tab shown in FIG. 24. The name 2505 of the campaign is listed. The ID 2510 of the campaign will be assigned once the creative is created. The name 2515 of the creative is also added. The type 2520 of the creative is listed. Types are formats, and can include, but are not limited to: over-the-air and/or a Wireless Application Protocol (WAP) downloading, sideloading (e.g., using a Subscriber Identity Mobile (SIM) card), bundling with another application, sending through a Systems Management Server (SMS), burning into a chipset, forwarding from another entity or person (e.g., using Bluetooth technology), or utilizing Binary Runtime Environment for Wireless (BREW), Java, Java Micro Edition (JME) (e.g., Blackberry, MIDP2, CLCD, CDC), Multimedia Messaging Service (MMS), FlashLite, Windows Mobile (e.g., PocketPC, SmartPhone), Palm OS, Symbian, iPhone, Linux, Android, Danger Hiptop Operating System, or Real-Time Operating Systems (RTOS) (e.g., REX RTOX). In addition, note that any combination of the above can also be used.

The status 2525 of the creative is also listed. The first date 2530 and last date 2535 for the creative to run are also listed. The slot 2540 lists the time slot that the creative is to run. The age 2545, income 2550, education 2555, geographics 2560, and gender 2565 are all demographic fields that can be used to target particular advertising to a particular demographic. The assignments 2570 indicate which campaign this creative is assigned to. The save 2575 and cancel 2585 buttons allow the user to save or cancel this creative. The check availability button 2580 allows the user to check whether a certain time slot is available. In one embodiment, this is done by the user entering a requested time slot, and the ad center service checking to see if any other entity has requested this time slot and/or other targeting criteria. In one embodiment, if another entity has requested the time slot and/or targeting criteria, the ad center service can display any conflicting advertising already scheduled.

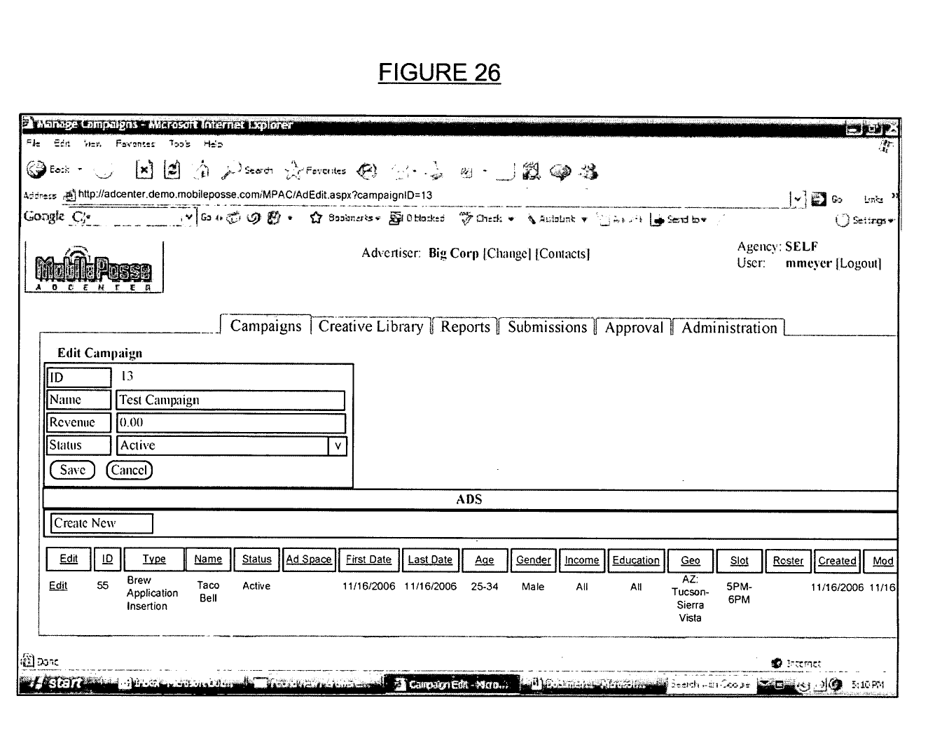

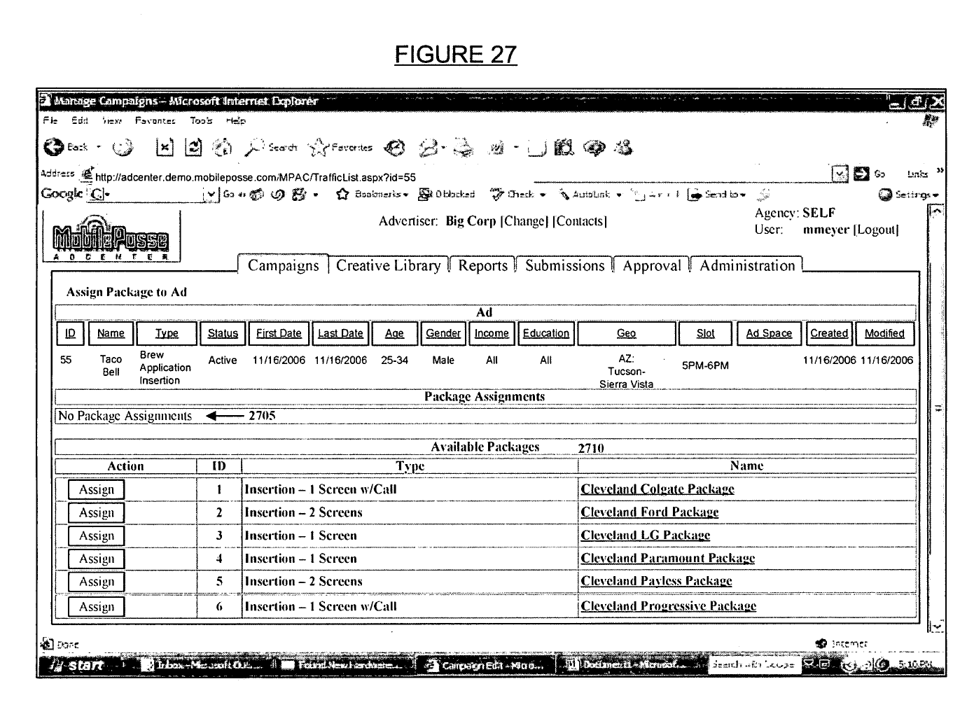

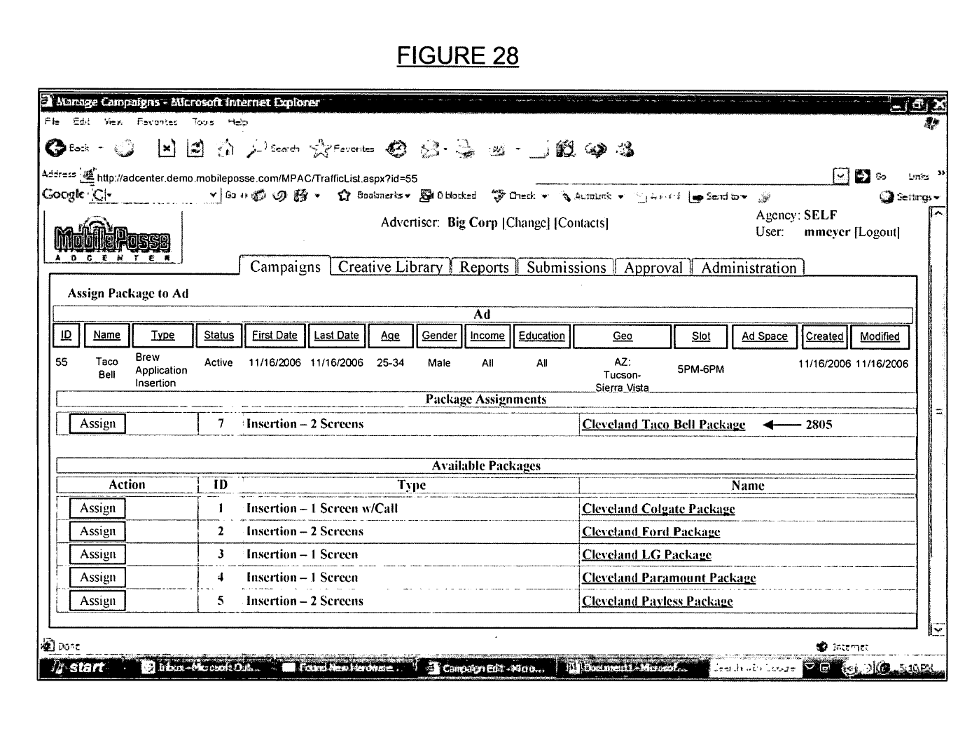

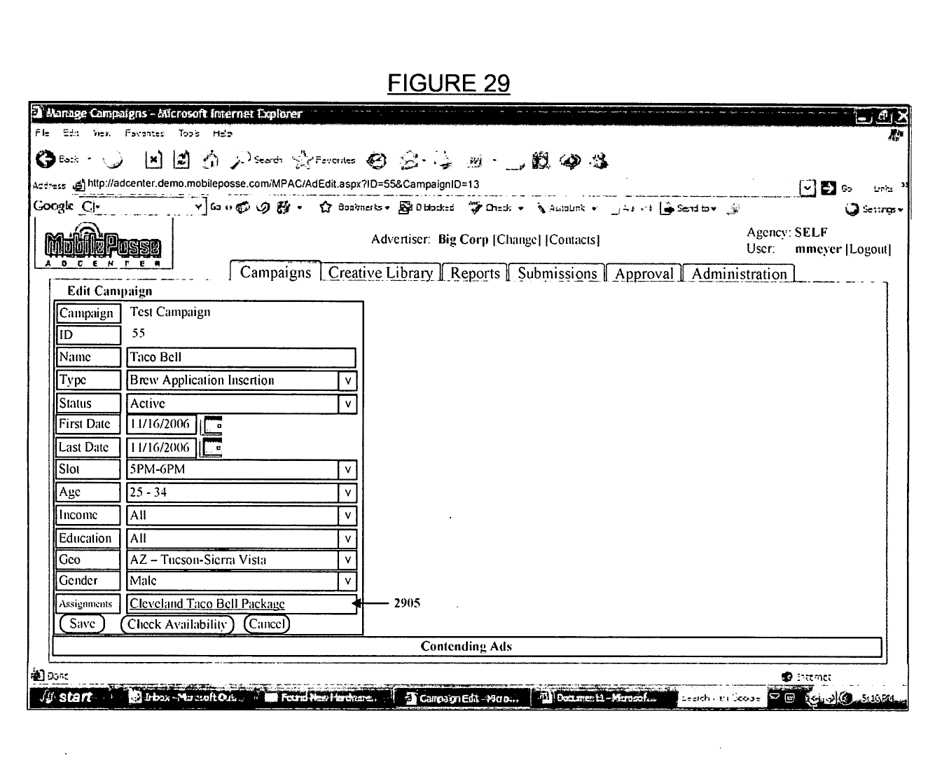

FIG. 26 is a screen shot in the ad center service illustrating how the advertising (i.e., creative) created in FIG. 25 is added to the edit campaign tab described in FIG. 24. Thus, if a user of the ad center service saves the package entitled “test” that it created in FIG. 25, it is added to the top of the list of creatives in FIG. 26 (compare this with the list of creatives in FIG. 24). FIG. 27 is a screen shot in the ad center service illustrating the assignments of packages to campaigns. As indicated above, a package includes a creative with targeting requirements. The package assignments option 2705 indicates that no packages have been assigned to this campaign. The available packages 2710 list all packages which are available for this campaign. FIG. 28 is a screen shot in the ad center service illustrating a package assignment 2805 being added to the package assignment option. As compared with FIG. 27, which has no package assignments, FIG. 28 has a package assignment 2805 which is named Cleveland Taco Bell Package. FIG. 29 is a screen shot in the ad center service illustrating where the package assignment 2905 is listed in the assignment 2570 on FIG. 25.

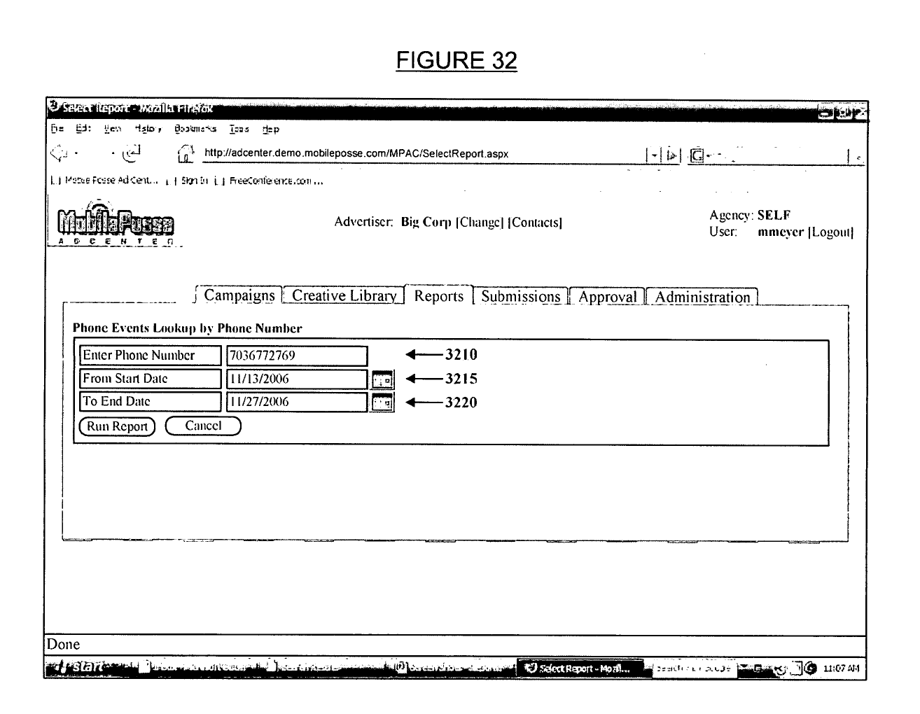

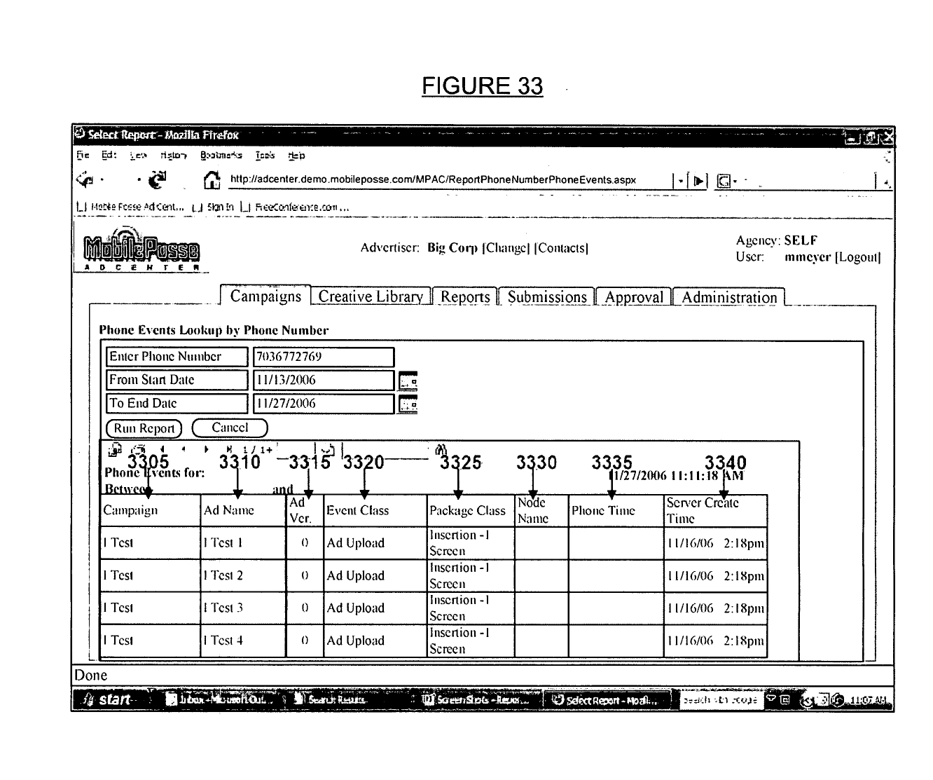

FIG. 31 is a screen shot in the report center service illustrating how reports are selected. As illustrated in FIG. 30, several reports are available. One example is the phone transaction (or number) report 3005 which has been chosen in FIG. 31. As explained with respect to FIG. 30, this report lists all transactions (e.g., advertising sent, advertising shown to consumer, actions on the advertising) over a period of time for a particular account (e.g., tied to a phone number). FIG. 32 is a screen shot in the report center service illustrating the inputs required to generate a phone events lookup by phone number report. The enter phone number 3210 allows the user to enter the phone number of interest. The start date 3215 and end date 3220 allow the user to enter the date range of interest for the report. FIG. 33 is a screen shot in the report center service illustrating the phone events lookup by phone number report. The campaign 3305, advertising name 3310, advertising 3315, event class 3320, package class 3325, node name 3330, phone time 3335, and server create time 3340 are all listed in the report.

The submissions tab 1620 can provide a queue of packages that are ready to be approved. In one embodiment, the submission option can be utilized by an entity such as a carrier that does not need the multiple levels of approval for a package that are allowed in the approval tab 1625 (e.g., creative upload, targeting, scheduling). For example, in a carrier situation, the carrier may only need to review the package to make sure, for example, that it does not contain content associated with a competing carrier and that it does not contain disallowed content (e.g., pornography). The submissions option can thus be a simple approval process used instead of or in addition to the approval option.

FIG. 34 is a screen shot in the ad center service illustrating details of the approval tab 1625. FIG. 34 lists all of the packages that are approved. (Submissions are packages that are not yet approved.) If a user of the ad center service chooses an edit option in FIG. 34, the screen shot of FIG. 35 will appear. FIG. 35 includes information on the package chosen. This information includes the assigned ID number 3505, the name of the package 3510, the status of the package 3520 (e.g., active, inactive, deleted), a box to check whether the package is approved 3525, and a field to designate whether the package is complete 3530. Once the package has been edited, it can be saved 3535 or cancelled 3540. A list of images 3545 is also included, which can be edited.

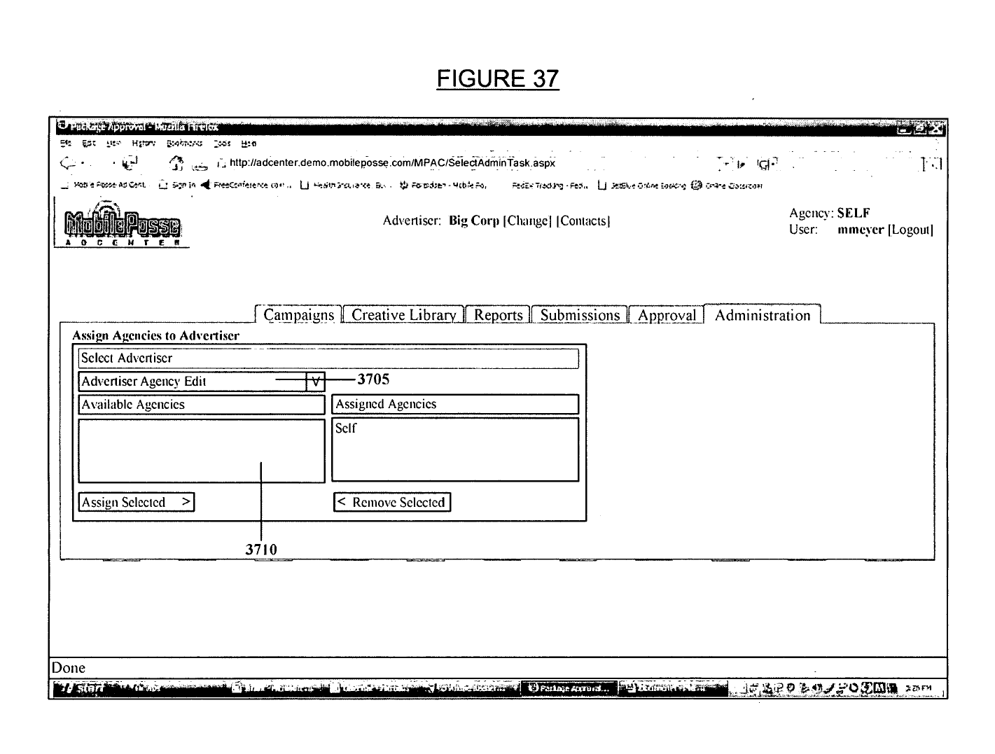

FIG. 36 is a screen shot in the ad center service illustrating details of the administrator tab 1630. In selecting administrative task 3605, a list of tasks is included, such as advertiser agency edit, manage users, manage phones, manage phone models, manage roles, manage rosters, and manage sales people. (Note that a roster is a collection of accounts to deliver packages to. Typically, a roster has a common set of targeting attributes but may also have random attributes for testing purposes.) If the advertiser agency edit is chosen, in FIG. 37 a selected advertiser 3705 can be assigned to a specific agency from a list of available agencies 3710.

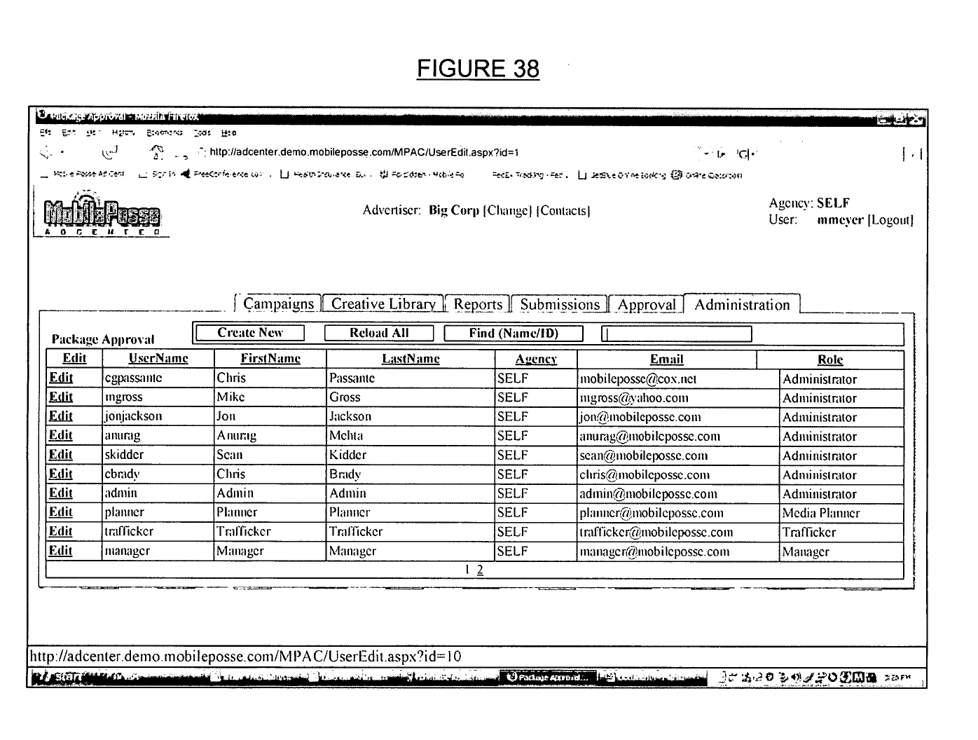

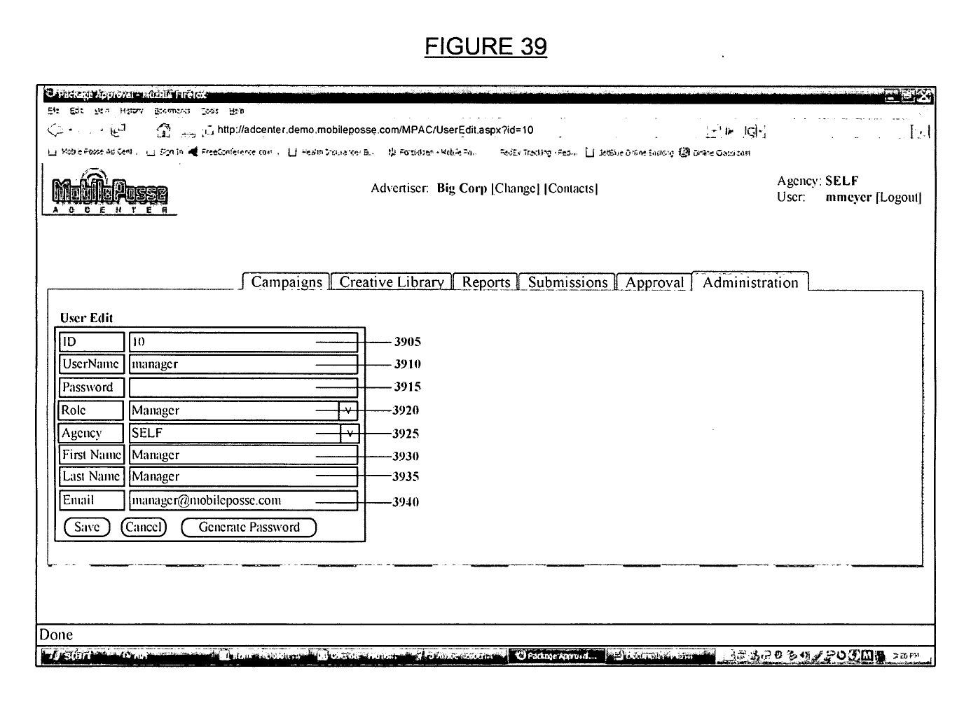

If the manage users option is chosen, in FIG. 38, a list of users is provided. If the edit button is chosen, the user information of a particular user can be edited according to the screen shot of FIG. 39, which contains information about a particular user of the ad center service, including the user's ID 3905, the user's name 3910, the user's password 3915, the user's role 3920, the user's agency 3925, the user's first name 3930, the user's last name 3935, and the use's email 3940.

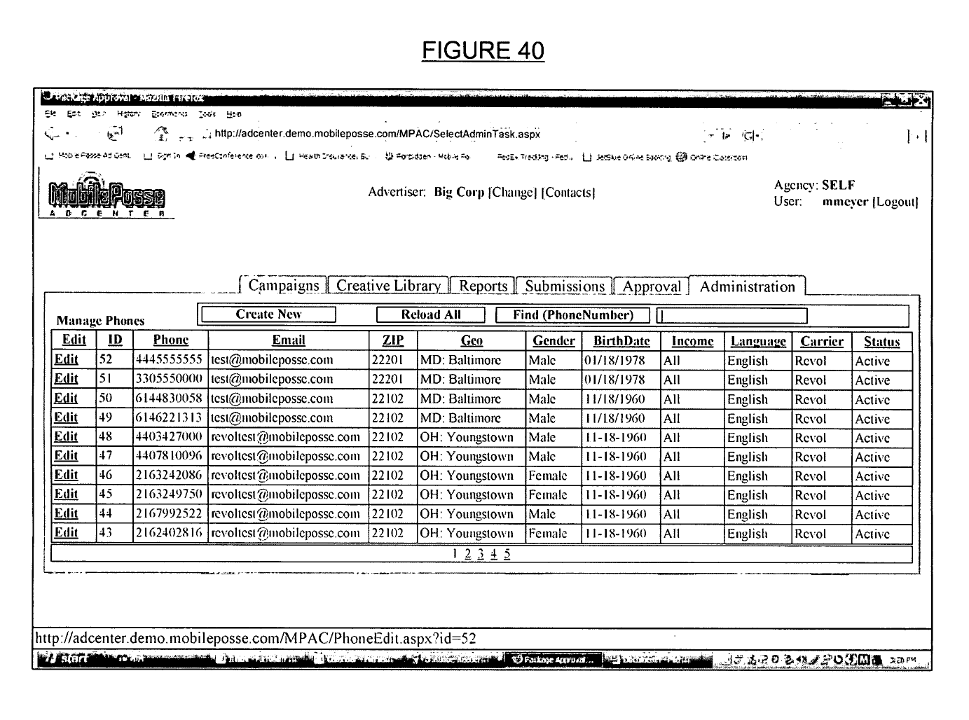

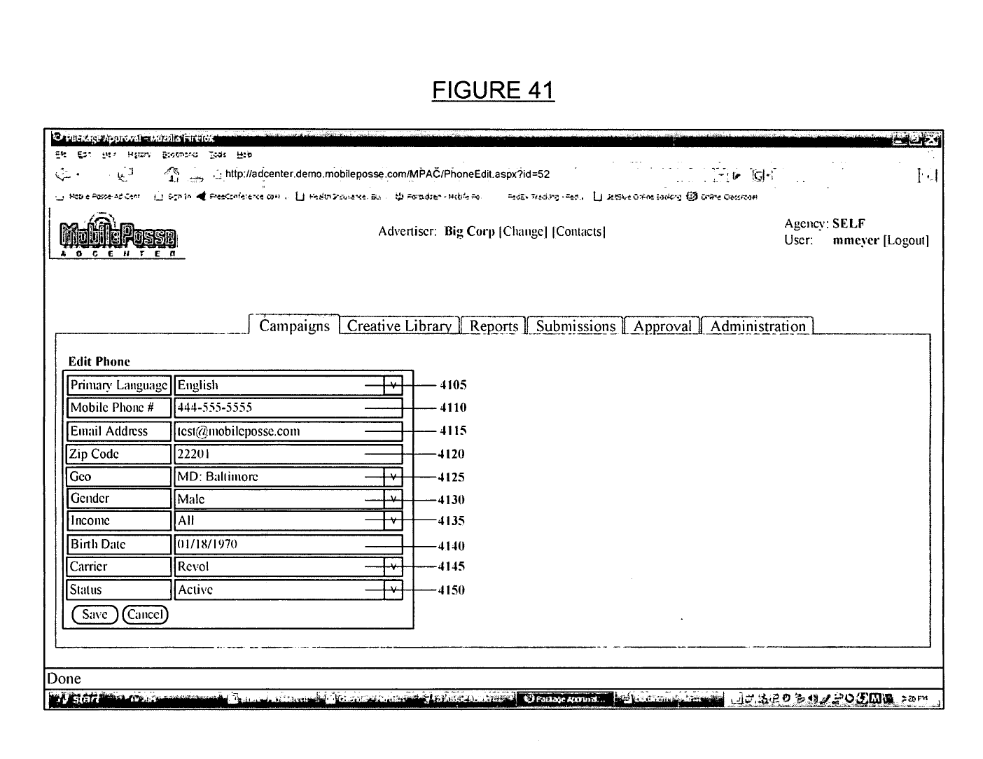

If the manage phones option is chosen, in FIG. 40, a list of phones and/or mobile handheld devices is provided. If the edit button is chosen, the information of a particular mobile handheld device can be edited according to the screen shot of FIG. 41, which contains information regarding the user registered with the mobile handheld device, including the user's primary language 4105, mobile phone number 4110, email address 4115, zip code 4120, geographic area 4125, gender 4130, income 4135, birth date 4140, carrier 4145, and status 4150. In one embodiment, the first name, last name, and/or zip code of the owner of the mobile handheld device can also be included in the information regarding a particular mobile handheld device.

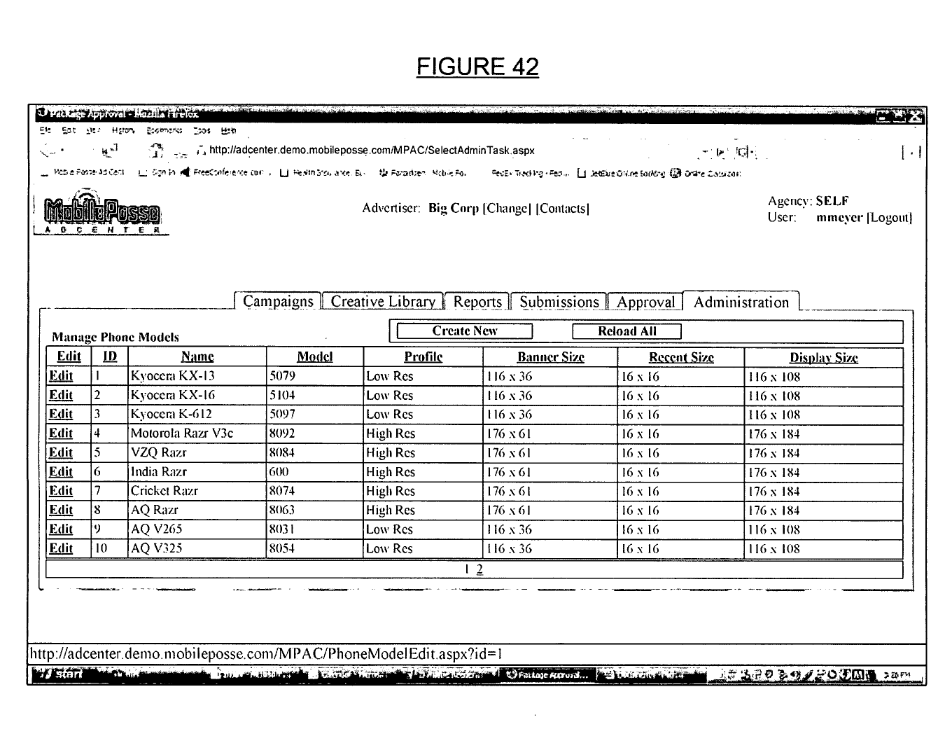

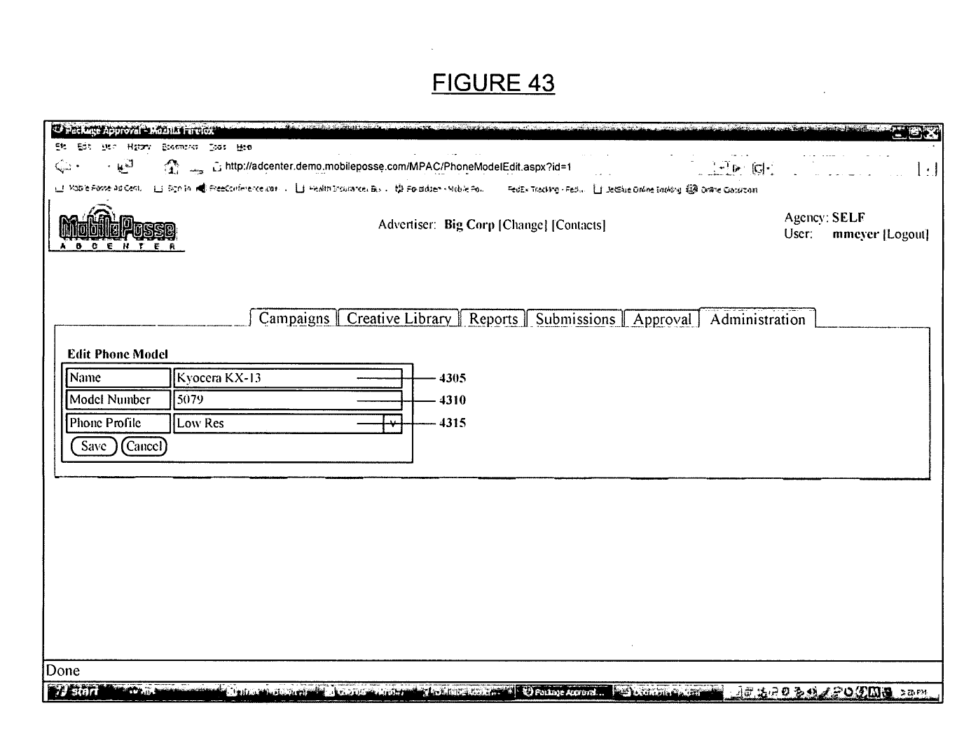

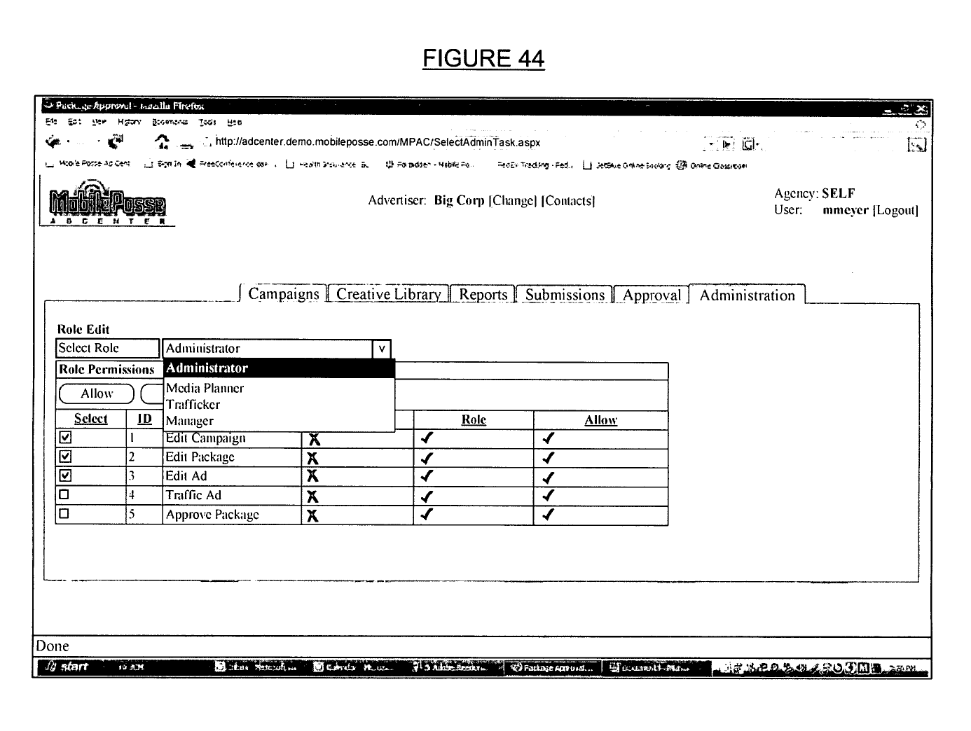

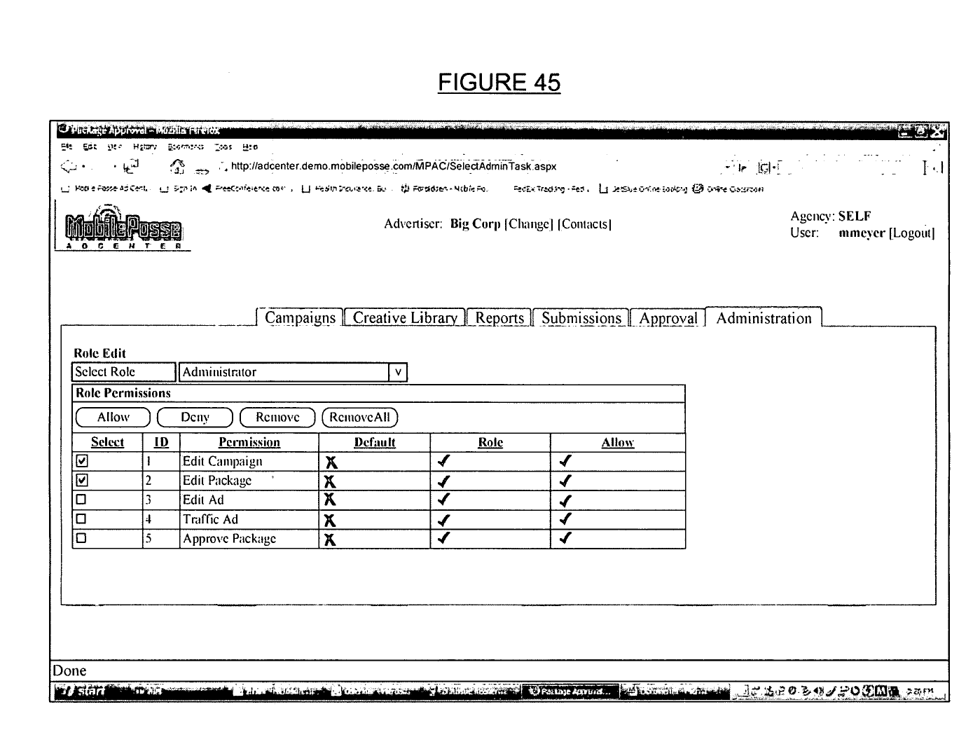

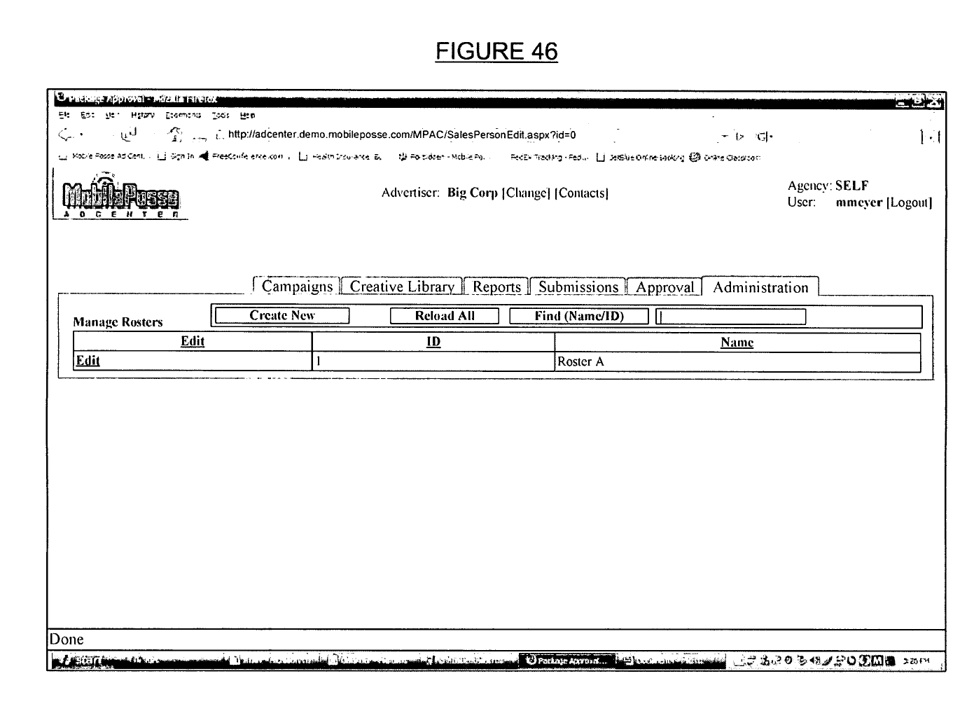

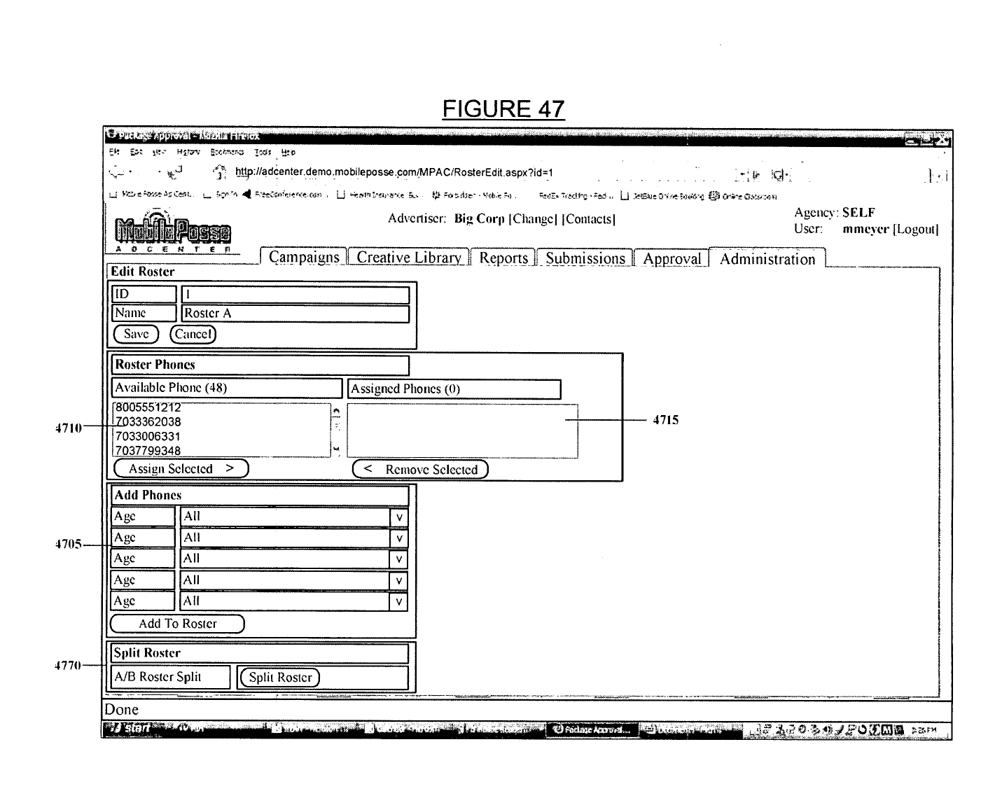

If the manage phone models option is chosen, in FIG. 42, a list of phone and/or mobile handheld device models is provided. If the edit button is chosen, the information of a particular model can be edited according to the screen shot of FIG. 43, which contains information regarding the user registered with the mobile handheld device, including name 4305, model number 4310, and phone profile 4315. In FIG. 44, the role of a user of the ad center service can be edited. For example, if the roles are administrator, media planner, trafficker, and manager, the administrator role can be chosen and edited in FIG. 45. A list of permissible actions is displayed (e.g., edit campaign, edit package, edit ad, traffic ad, approve package), with a list of what level of permission is given for each action. A given permission is either allowed (i.e., granted) or denied for a given role. Each permission has a default value. Thus, a red X in the default column indicates that, by default, permission is denied for all roles. A green check in the default column indicates that, by default, the permission is granted for all roles. A permission can also be allowed or denied explicitly for a given role, overriding the default value. Thus, a green check in the role column indicates that the permission has been explicitly granted for that role. A red check indicates that the permission has been denied for that role. The column will be blank if the permission has not been overridden for that role. The allow column is the effective result (granted or denied) of a permission for a given role. A red check indicates that the role has not been granted that permission. A green check indicates that the role has been granted that permission. In one embodiment, an additional user column could be added to explicitly allow or deny permission for a given user. This user permission would override a role which would override the default. In FIG. 46, rosters can be managed. Rosters are groups of users that are divided, such as for testing purposes. If the edit rosters option is chosen, than in FIG. 47 the roster can be edited. In the add phones option 4705, different criteria can be selected. In available phones 4710, the phones that match the criteria appear. In 4715, available phones can be assigned to the roster which is being edited. In 4720, the roster can also be divided.

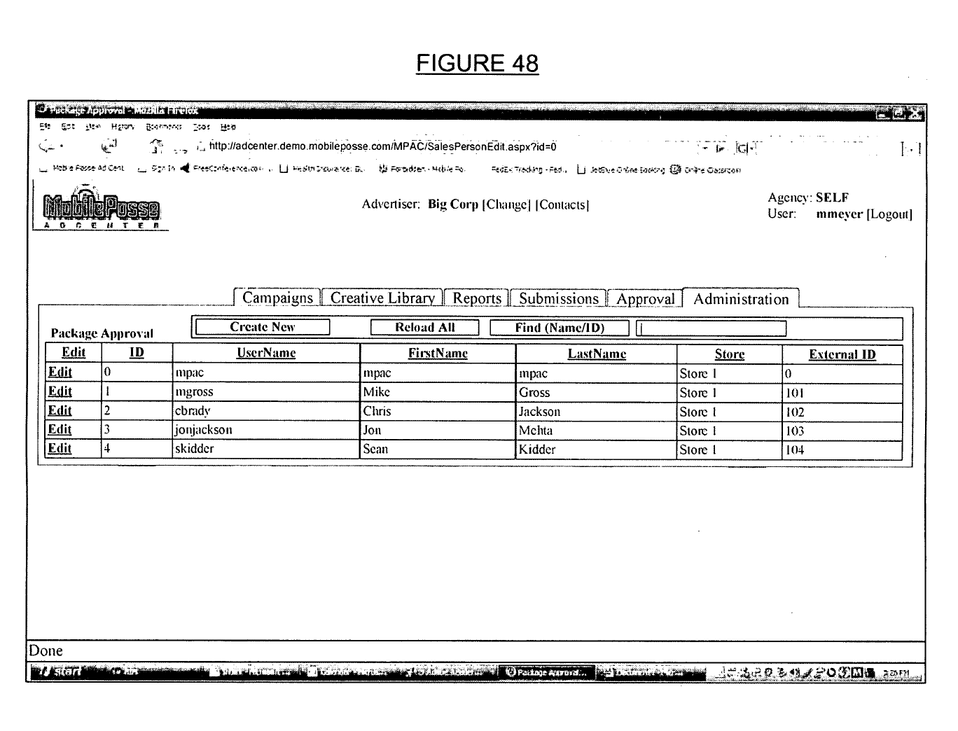

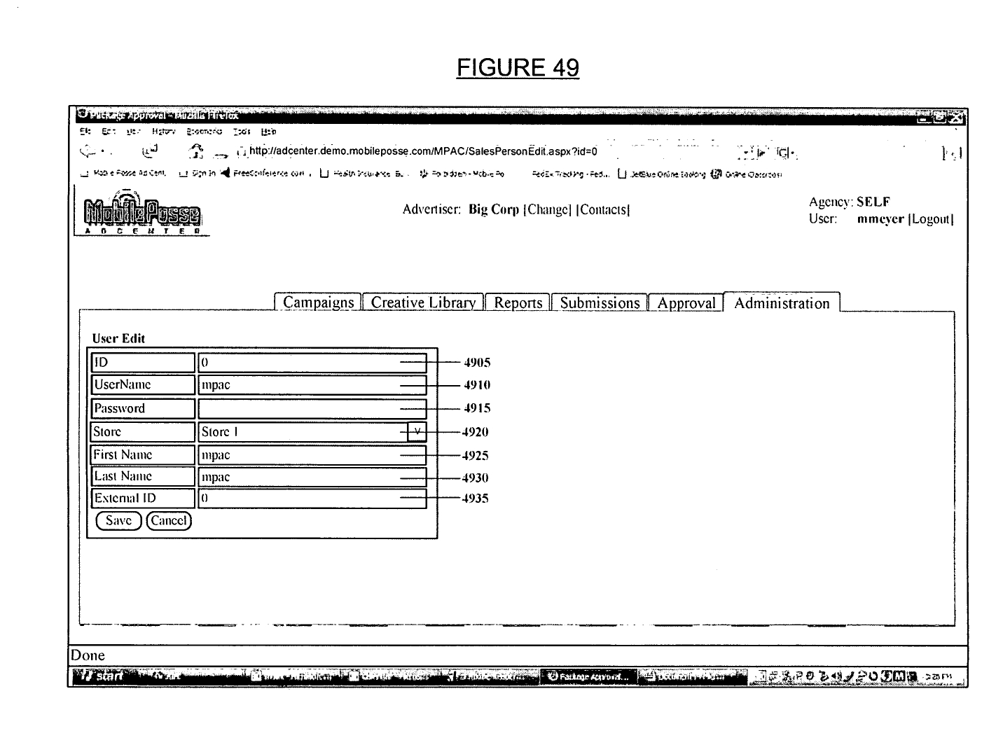

If the manage sales people option is chosen, in FIG. 48, a list of sales people is provided. If the edit button is chosen, the information of a particular person can be edited according to the screen shot of FIG. 49, which contains information regarding the sales person, including ID 4905, user name 4910, password 4915, store 4920, first name 4925, last name 4930, and external ID 4935.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

In addition, it should be understood that the figures, examples, and screen shots, which highlight the functionality and advantages of the present invention, are presented for example purposes only. The architecture of the present invention is sufficiently flexible and configurable, such that it may be utilized in ways other than that shown in the accompanying figures, examples, and screen shots.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed is:

1. A method for delivering and displaying content on a mobile handheld device with voice telephony capability, comprising:
receiving content from or on behalf of a content provider;
determining, for each individual one of a plurality of mobile handheld devices, content appropriate for each device;
delivering individually to the one mobile handheld device the content determined to be appropriate for that mobile handheld device;
determining whether a mobile handheld device is in an internal and/or external predetermined status, wherein the internal predetermined status is a function of the mobile handheld device unrelated to the content; and
if the mobile handheld device is in the internal and/or external predetermined status, displaying the content as a foreground to a top-level user interface of the mobile handheld device.

2. The method of claim 1, wherein the internal predetermined status is:
the mobile handheld device is idle.

3. The method of claim 1, wherein the internal predetermined status is when there is:
a reception device event;
a time event;
a location event;
a user input and/or interaction event;
a telephony event;
a signal strength event;
a movement of the device;
a power related event; or
incoming/outgoing content; or
any combination thereof.

4. The method of claim 1, wherein the external predetermined status is when there is:
a sound where the mobile handheld device is located;
a motion where the mobile handheld device is located;
an event impacting the user of the mobile handheld device;
a temperature where the mobile handheld device is located;
a location where the mobile handheld device is located;
a geographic profile of locations the user frequents, or
an combination thereof.

5. The method of claim 1, further comprising a user of the mobile handheld device interacting with the displayed content.

6. The method of claim 5, wherein the interacting comprises:
completing an activity related to the content;
connecting through a telephone call to an entity related to the content or an entity that can receive content;
forwarding the content to an entity;
connecting to a web site related to the content;
receiving a download based on information in the content;
connecting with an entity related to the content via postal mail; or
connecting to an application that is related to the content or can be received by the content; or
any combination thereof.

7. The method of claim 6, wherein the download comprises:
a ring tone for the mobile handheld devices;
a screen saver for the mobile handheld devices;
an application for the handheld device;
a video for the mobile handheld device; or
a game for the mobile handheld devices; or
any combination thereof.

8. The method of claim 5, further comprising:
tracking the interaction of the users of the mobile handheld devices with the content; and/or
tracking the satisfaction of the users.

9. The method of claim 1, further comprising:
inserting the content into a content list accessible by the users of the mobile handheld device.

10. The method of claim 1, wherein the users of the mobile handheld device may choose and/or be required to register in order to customize the content.

11. The method of claim 1, wherein data is generated comprising information about:
system performance, billing, revenue, or performance of the content, or any combination thereof.

12. The method of claim 11, wherein the billing information is based upon length of user engagement.

13. The method of claim 1, wherein the content is determined to be appropriate for each device based upon user parameters comprising: geography, demographics, psychographics (personality characteristics and attitudes that affect a person's lifestyle and purchasing behavior), mobile handheld device characteristics, consumer rosters, user specified preferences, client-side targeting decisions, search results, application usage behavior, or time, or any combination thereof.

14. The method of claim 1, wherein the mobile handheld device comprises:
a cellular phone;
a personal digital assistant (PDA);
a GPS mobile handheld device; or
or any combination thereof.

15. The method of claim 1, wherein the content comprises:
advertising;
movies;
songs;
ring tones;
wallpapers;
mobile games;
video content;
audio content
video/audio content;
graphical content;
textual content;
digital content;
software applications;
rich media;
public service announcements;
trivia;
weather;
a call to action;
polling;
surveys;
data;
services;
mobile handheld device specific content;
graphic media;
animation media; or
any combination thereof.

16. The method of claim 1, further comprising generating data, the generated data related to:
information related to an individual or mobile handheld device;
information illustrating the average check-in time and meantime between check-ins;
information relating to time to distribute the content to the mobile handheld devices;
information about account creations, cancels, suspends, and other status changes over a period of time;
information about active customer accounts;
effective pricing information;
information to support billing;
information related to transactions;
information related to level of user engagement;
invoice information describing amounts to be charged to an advertiser/agency based upon an advertising purchase model;
information on interactions;
information about an amount of content delivered and/or displayed;
return on investment information;
off-phone conversion information;
information about how much consumer progress is made during an interactive process;
information about costs of acquiring subscribers; or
information about how long a user of a mobile handheld device spent looking at content;
or any combination thereof.

17. The method of claim 16, wherein the generated data is:
collected;
analyzed; or
derived; or
any combination thereof.

18. The method of claim 1, wherein a content list is kept on the mobile handheld device, the content list comprising recently presented content and/or other content.

19. The method of claim 1, wherein the content is delivered to the mobile handheld device at a time based upon: network usage, content value, revenue opportunity, information timeliness, mobile handheld device capabilities, carrier specifications, geo or location based information, or user demand; or any combination thereof.

20. The method of claim 1, further comprising utilizing: type capping, frequency capping, device capping, impression capping, action capping, or conversion, or any combination thereof.

21. The method of claim 1, further comprising a user of the mobile handheld device who receives the content, forwarding the content to another device.

22. The method of claim 1, further comprising a user of the mobile handheld device who receives the content rating the content in order to convey:
a level of satisfaction;
a level of timeliness of delivery;
whether the user has viewed the content and/or how long the user has viewed the content;
a level of value;
a level of quality;
a level of relevance; or
a level of appropriateness; or
any combination thereof.

23. The method of claim 1, wherein the content provider supplies desired parameters which assist in determining the content delivered to each device.

24. The method of claim 1, wherein the content is displayed as a floating foreground overlying a top-level user interface.

25. The method of claim 1, wherein the content is displayed at a time subsequent to the session in which the content was delivered.

26. A system for delivering and displaying content on a mobile handheld devices with voice telephony capability, comprising:
a server coupled to a network;
a user terminal coupled to the network;
an application coupled to the server and/or the user terminal, wherein the application is configured for:
receiving content from or on behalf of a content provider;
determining, for each individual one of a plurality of mobile handheld devices, content appropriate for each device;
delivering individually to the one mobile handheld device the content determined to be appropriate for that mobile handheld device;
determining whether a mobile handheld device is in an internal and/or external predetermined status, wherein the internal predetermined status is a function of the mobile handheld device unrelated to the content; and
if the mobile handheld device is in the internal and/or external predetermined status, displaying the content as a foreground to a top-level user interface of the mobile handheld device.

27. The system of claim 26, wherein the internal predetermined status is:
the mobile handheld device is idle.

28. The system of claim 26, wherein the internal predetermined status is when there is:
a reception device event;
a time event;
a location event;
a user input and/or interaction event;
a telephony event;
a signal strength event;
a movement of the device;
a power related event; or
incoming/outgoing content; or
any combination thereof.

29. The system of claim 26, wherein the external predetermined status is when there is:
a sound where the mobile handheld device is located;
a motion where the mobile handheld device is located;
an event impacting the user of the mobile handheld device;
a temperature where the mobile handheld device is located;
a location where the mobile handheld device is located;
a geographic profile of locations the user frequents, or
an combination thereof.

30. The system of claim 26, wherein the application is further capable of enabling a user of the mobile handheld device to interact with the displayed content.

31. The system of claim 30, wherein the interacting comprises:
completing an activity related to the content;
connecting through a telephone call to an entity related to the content or an entity that can receive content;
forwarding the content to an entity;
connecting to a web site related to the content;
receiving a download based on information in the content;
connecting with an entity related to the content via postal mail; or
connecting to an application that is related to the content or can be received by the content; or
any combination thereof.

32. The system of claim 31, wherein the download comprises:
a ring tone for the mobile handheld devices;
a screen saver for the mobile handheld devices;
an application for the handheld device;
a video for the mobile handheld device; or
a game for the mobile handheld devices; or
any combination thereof.

33. The system of claim 30, wherein the application is further configured for:
tracking the interaction of the users of the mobile handheld devices with the content; and/or
tracking the satisfaction of the users.

34. The system of claim 26, wherein the application is further configured for:
inserting the content into a content list accessible by the users of the mobile handheld device.

35. The system of claim 26, wherein the users of the mobile handheld device may choose and/or be required to register in order to customize the content.

36. The system of claim 26, wherein data is generated comprising information about: system performance, billing, revenue, or performance of the content, or any combination thereof.

37. The system of claim 36, wherein the billing information is based upon length of user engagement.

38. The system of claim 26, wherein the content is determined to be appropriate for each device based upon user parameters comprising: geography, demographics, psychographics (personality characteristics and attitudes that affect a person's lifestyle and purchasing behavior), mobile handheld device characteristics, consumer rosters, user specified preferences, client-side targeting decisions, search results, application usage behavior, or time, or any combination thereof.

39. The system of claim 26, wherein the mobile handheld device comprises:
a cellular phone;
a personal digital assistant (PDA);
a GPS mobile handheld device; or
or any combination thereof.

40. The system of claim 26, wherein the content comprises:
advertising;
movies;
songs;
ring tones;
wallpapers;
mobile games;
video content;
audio content
video/audio content;
graphical content;
textual content;
digital content;
software applications;
rich media;
public service announcements;
trivia;
weather;
a call to action;
polling;
surveys;
data;
services;
mobile handheld device specific content;
graphic media;
animation media; or
any combination thereof.

41. The system of claim 26, wherein the application is further configured for generating data, the generated data related to:
information related to an individual or mobile handheld device;
information illustrating the average check-in time and meantime between check-ins;
information relating to time to distribute the content to the mobile handheld devices;
information about account creations, cancels, suspends, and other status changes over a period of time;
information about active customer accounts;
effective pricing information;
information to support billing;
information related to transactions;
information related to level of user engagement;
invoice information describing amounts to be charged to an advertiser/agency based upon an advertising purchase model;
information on interactions;
information about an amount of content delivered and/or displayed;
return on investment information;
off-phone conversion information;
information about how much consumer progress is made during an interactive process;
information about costs of acquiring subscribers; or
information about how long a user of a mobile handheld device spent looking at content;
or any combination thereof.

42. The system of claim 41, wherein the generated data is:
collected;
analyzed; or
derived; or
any combination thereof.

43. The system of claim 26, wherein a content list is kept on the mobile handheld device, the content list comprising recently presented content and/or other content.

44. The system of claim 26, wherein the content is delivered to the mobile handheld device at a time based upon: network usage, content value, revenue opportunity, information timeliness, mobile handheld device capabilities, carrier specifications, geo or location based information, or user demand; or any combination thereof.

45. The system of claim 26, wherein the application is configured for utilizing: type capping, frequency capping, device capping, impression capping, action capping, or conversion, or any combination thereof.

46. The system of claim 26, wherein the application is configured for enabling a user of the mobile handheld device who receives the content to forward the content to another device.

47. The system of claim 26, wherein the application is configured for enabling a user of the mobile handheld device who receives the content to rate the content in order to convey:
a level of satisfaction;
a level of timeliness of delivery;
whether the user has viewed the content and/or how long the user has viewed the content;
a level of value;
a level of quality;
a level of relevance; or
a level of appropriateness; or
any combination thereof.

48. The system of claim 26, wherein the content provider supplies desired parameters which assist in determining the content delivered to each device.

49. The system of claim 26, wherein the content is displayed as a floating foreground overlying a top-level user interface.

50. The system of claim 26, wherein the content is displayed at a time subsequent to the session in which the content was delivered.
